(19) United States
(12) Patent Application Publication
(10) Pub. No.: US 2026/0278350 A1
(43) Pub. Date: Sep. 17, 2026

(54) SYSTEM

(71) Applicant: SoftBank Group Corp., Tokyo (JP)

(72) Inventor: Shintaro TSUCHIYA, Tokyo (JP)

(73) Assignee: SoftBank Group Corp., Tokyo (JP)

(21) Appl. No.: 19/547,726

(22) Filed: Feb. 24, 2026

Related U.S. Application Data
(60) Provisional application No. 63/772,137, filed on Mar. 14, 2025.

(51) Int. Cl. G06N 3/0475; G06N 3/047; G06Q 50/26

(52) U.S. Cl. CPC G06N 3/0475; G06N 3/047; G06Q 50/265

(57) ABSTRACT

A system includes a processor that is configured to acquire meteorological information as weather information from at least one external source, acquire sensor data from at least one sensor, analyze the weather information and the sensor data to generate an analysis result, predict an occurrence of a natural disaster based on the analysis result, generate an alert relating to the predicted natural disaster, and notify the alert to related organizations and residents.

### CROSS-REFERENCE TO RELATED APPLICATION

This application claims the benefit of U.S. Provisional Application No. 63/772,137 filed on Mar. 14, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional early warning systems for natural disasters often rely on limited types of data or simple threshold-based rules, resulting in low accuracy or delayed issuance of alerts. In particular, many systems do not sufficiently integrate diverse meteorological information and various sensor data, and therefore fail to capture complex patterns that precede natural disasters such as floods, landslides, and earthquakes. As a consequence, alerts may be issued too late, may not reflect the true scale or regional concentration of the risk, or may generate frequent false alarms that reduce public trust. Furthermore, existing systems frequently do not provide rich alert content including the type, scale, high-probability region, and predicted occurrence time of the natural disaster in a coordinated manner across multiple notification channels. Thus, there is a need for a system that can comprehensively acquire meteorological information and sensor data, analyze them with higher accuracy, predict the occurrence of natural disasters based on the analysis results, and rapidly notify detailed alerts to relevant organizations and residents via multiple communication means.

### SUMMARY

To solve the above-described problems, the invention provides a system comprising a processor, wherein the processor is configured to acquire meteorological information as weather information from at least one external source and acquire sensor data from at least one sensor, and to analyze the weather information and the sensor data to generate an analysis result. The processor is further configured to predict an occurrence of a natural disaster based on the analysis result and to generate an alert relating to the predicted natural disaster. The processor is also configured to notify the alert to related organizations and residents. In one aspect, the processor is configured to compare past natural-disaster data with current weather information and current sensor data, and to recognize patterns using a machine learning algorithm, so as to predict the occurrence of the natural disaster with improved accuracy. In another aspect, the processor is configured to notify, using at least one of email, SMS, a dedicated application, and a public alert system, the alert including at least a type of the predicted natural disaster, a scale of the predicted natural disaster, a region having a high probability of the occurrence of the predicted natural disaster, and a predicted occurrence time of the predicted natural disaster, thereby enabling rapid, detailed, and widely disseminated early warnings.

The term “processor” refers to one or more hardware circuits, such as a central processing unit (CPU), microprocessor, microcontroller, digital signal processor (DSP), application specific integrated circuit (ASIC), field programmable gate array (FPGA), or any combination thereof, that executes instructions to perform the functions described in the claims.

The term “meteorological information” refers to information relating to atmospheric and weather conditions, including but not limited to temperature, humidity, precipitation, wind speed, wind direction, and atmospheric pressure, which is acquired from at least one external source such as a weather service or meteorological agency.

The term “weather information” refers to meteorological information that represents current or forecasted weather conditions for a given region and time, including, for example, data obtained from weather satellites, ground-based weather stations, or other meteorological observation systems.

The term “external source” refers to any system, device, server, service provider, or database that is located outside the system comprising the processor and that supplies meteorological information or other data via a communication network or interface.

The term “sensor data” refers to data acquired from one or more sensors that measure physical or environmental parameters, such as water level, ground movement, seismic activity, slope angle, or other conditions relevant to the occurrence of natural disasters.

The term “sensor” refers to any device or apparatus configured to measure or detect a physical, environmental, or geophysical parameter, including but not limited to seismometers, water-level gauges, rainfall gauges, landslide sensors, tilt sensors, and other environmental monitoring instruments.

The term “analysis result” refers to information generated by processing and analyzing the weather information and the sensor data, including but not limited to derived features, detected patterns, or intermediate indicators used for predicting the occurrence of a natural disaster.

The term “natural disaster” refers to an adverse event caused by natural phenomena, including but not limited to floods, landslides, earthquakes, tsunamis, typhoons, hurricanes, heavy rainfall events, and similar natural hazards.

The term “predict an occurrence of a natural disaster” refers to estimating, based on the analysis result, whether a natural disaster is likely to occur, including, for example, assessing a probability, risk level, or likelihood that a natural disaster will occur within a specified region and time window.

The term “alert” refers to information generated by the system to notify relevant parties of a predicted natural disaster, the alert including at least data relating to the type, scale, high-probability region, and predicted occurrence time of the natural disaster.

The term “related organizations” refers to public or private entities that are responsible for disaster management, emergency response, infrastructure operation, or public safety, such as government agencies, local authorities, disaster prevention organizations, and utility companies.

The term “residents” refers to individuals or groups of people who live in, work in, or are otherwise present in a region that may be affected by a predicted natural disaster and who are intended recipients of alerts generated by the system.

The term “past natural-disaster data” refers to historical data relating to previously occurred natural disasters, including records of their occurrence times, locations, types, scales, sensor readings, and meteorological conditions before and during the events.

The term “current weather information” refers to meteorological information representing substantially real-time or recent weather conditions at or near the time the system executes the analysis and prediction processes.

The term “current sensor data” refers to sensor data representing substantially real-time or recent measurements obtained from sensors at or near the time the system executes the analysis and prediction processes.

The term “machine learning algorithm” refers to a computational method or model that learns patterns or relationships from data, such as regression models, decision trees, random forests, support vector machines, neural networks, or other statistical or data-driven algorithms, and that is used to recognize patterns associated with natural disasters.

The term “pattern” refers to a recognizable combination, correlation, or temporal or spatial relationship among weather information, sensor data, and historical data that is indicative of the potential occurrence, scale, or location of a natural disaster.

The term “email” refers to an electronic mail message transmitted over a communication network, such as the Internet, using standard email protocols to deliver alert information to an electronic mail address.

The term “SMS” refers to a Short Message Service text message transmitted over a mobile communication network to a mobile terminal, the SMS including alert information in a text format.

The term “dedicated application” refers to an application program installed on a terminal device, such as a smartphone, tablet, or personal computer, that is specifically configured to receive, display, and manage alerts generated by the system.

The term “public alert system” refers to a system operated by a governmental or public authority to disseminate alerts to a broad population, including but not limited to siren systems, broadcast systems, cell broadcast services, and public emergency notification platforms.

The term “type of the predicted natural disaster” refers to a classification identifying the kind of natural disaster predicted by the system, such as flood, landslide, earthquake, or other specific hazard type.

The term “scale of the predicted natural disaster” refers to an indicator representing the magnitude, severity, intensity, or expected impact of the predicted natural disaster, which may be expressed in qualitative levels or quantitative measures.

The term “region having a high probability of the occurrence of the predicted natural disaster” refers to a geographic area determined by the system in which the probability or risk level of the predicted natural disaster exceeds a predetermined threshold.

The term “predicted occurrence time of the predicted natural disaster” refers to a time or time window estimated by the system during which the predicted natural disaster is likely to occur, based on the analysis result and the prediction process.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

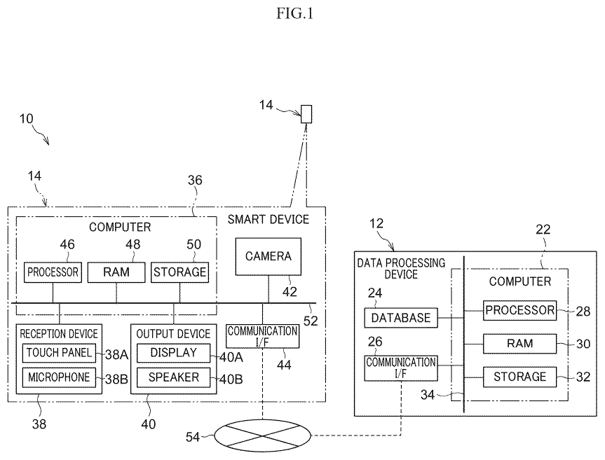

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

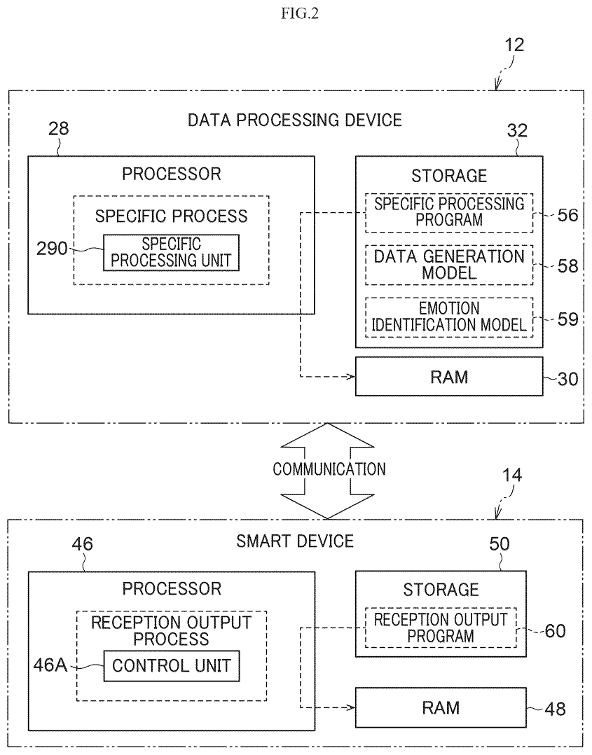

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional natural disaster early warning systems typically employ fixed rule sets or static machine learning models that are manually designed and periodically updated in an ad hoc manner. Such systems suffer from several technical limitations in terms of computer technology itself.

First, conventional systems generally ingest heterogeneous environmental data sources and sensor streams in a loosely coupled manner, without a unified mechanism for temporal and spatial alignment, quality control, and feature generation at scale. As a result, processing pipelines become brittle and inefficient, leading to high latency and inconsistent data representations across modules. This degrades the throughput and reliability of the overall computing system, particularly when processing large volumes of time-series and geospatial data in near real time.

Second, in many existing systems, prediction models for floods, earthquakes, landslides, and other natural disasters are trained and tuned in isolation using static configurations. When model performance degrades due to distributional shifts, new sensors, or new disaster patterns, engineers must manually design new feature sets, adjust hyperparameters, and rewrite model logic. This manual process is time-consuming, error-prone, and does not scale with the increasing complexity and size of incoming data. The computing system therefore lacks an efficient, automated feedback loop for continuously improving its predictive components.

Third, conventional systems often generate warning messages using hard-coded templates that are not dynamically adapted to current risk levels, user attributes, or communication media constraints. As a result, messages may be overly generic, overly technical, or too verbose or too short for a given channel. This not only reduces the practical effectiveness of alerts, but also forces developers to maintain a large number of static templates and rules, which complicates the software architecture and increases maintenance overhead.

Fourth, while some systems collect user feedback or field reports, such information is typically stored in separate logs or databases and is not systematically integrated back into the model training data or threshold calibration process. The computing platform thus fails to exploit an important source of real-world labels and corrections that could be used to reduce model bias and improve calibration. This leads to persistent inaccuracies in risk estimation and inefficient use of computing resources devoted to prediction and alerting.

Fifth, even when advanced learning methods are employed, existing architectures generally do not leverage generative AI models in a structured way for meta-level optimization of the prediction pipeline and alert generation logic. In particular, they lack a mechanism to encode current system state, error patterns, and performance targets into machine-interpretable prompt sentences, invoke a generative AI model to obtain algorithmic proposals, and automatically test and selectively incorporate such proposals into the running system. Consequently, the computing system does not benefit from a systematic, machine-assisted process for discovering improved feature engineering strategies, model architectures, or alert logic, and remains dependent on manual engineering iterations.

Accordingly, there is a need for an improved computer-implemented system that: (i) efficiently integrates multi-source environmental and sensor data into temporally and spatially aligned integrated data structures; (ii) automatically constructs and updates prediction models based on historical events and live data; (iii) incorporates generative AI models via structured prompt sentences to propose and evaluate improvements in feature sets, model configurations, thresholds, and warning texts; (iv) uses user feedback and field reports as auxiliary labels to refine model training and alert thresholds; and (v) dynamically generates and formats warning content tailored to different communication channels and user groups. Such a system should improve the technical performance of the underlying computing infrastructure in terms of robustness, adaptability, processing efficiency, and quality of outputs, rather than merely automating human decision-making.

The specific processing by the specific processing unit 290 of the data processing device 12 in Example 1 is realized by the following means.

The present invention provides a server comprising a processor and a memory storing instructions which, when executed by the processor, cause the server to acquire heterogeneous environmental information from multiple external information sources, temporally and spatially align the environmental information based on time information and position information, and store the aligned information as integrated data structures optimized for time-series and geospatial access; to receive observation information from a plurality of measurement devices, perform automated data quality operations including abnormality detection, duplication detection, missing-value completion, and noise removal based on physical and logical constraints, and generate feature data by associating the cleaned observation information with the integrated data; to compute, using the integrated data and the feature data, derived indicators for multiple types of natural phenomena, generate region-based and time-based input data sequences, and construct training data sets including labeled disaster occurrence information for supervised training; to train and register prediction models using statistical learning or deep learning methods and to periodically apply the trained prediction models to freshly updated input data sequences so as to compute occurrence probabilities, risk indicators, and danger levels for each region and each type of natural disaster; to generate structured prompt sentences that describe current model configurations, data configurations, misjudgment patterns, and performance objectives, provide the prompt sentences to a generative AI model, receive proposal information comprising at least one of feature generation methods, model architectures, threshold settings, and warning text drafts, automatically instantiate experimental configurations based on the proposal information, evaluate the experimental configurations using predefined metrics, and selectively update the prediction models, danger level determination logic, and warning text generation logic when the predefined metrics indicate improvement; to generate warning data including warning levels, target regions, time margins, and recommended actions based on the computed danger levels, predicted occurrence times, and predicted influence ranges, convert the warning data into machine-readable and human-readable formats adapted to different distribution channels, and transmit the warning data via multiple communication interfaces; and to receive warning reception confirmations and on-site situation reports from user terminals, associate such feedback with the integrated data and the danger levels as auxiliary labels, and employ the auxiliary labels in subsequent retraining and threshold adjustment operations. This enables a technical improvement in computer functionality by providing an adaptive, closed-loop processing architecture that integrates multi-source environmental data, machine learning prediction models, generative AI-assisted optimization via structured prompt sentences, and user feedback into a unified system, thereby enhancing processing efficiency, robustness, and quality of predictive and alert outputs beyond what is achievable with conventional static rule-based or manually tuned systems.

The term “environmental information” refers to data representing physical conditions of the natural environment, including but not limited to precipitation, air temperature, humidity, wind speed, wind direction, atmospheric pressure, water level, ground displacement, and seismic waveform values, obtained from external information sources such as remote sensing platforms and observation networks.

The term “external information source” refers to any system, service, database, or device that provides environmental information via a communication network, including remote sensing systems, meteorological information services, and geospatial data services.

The term “observation information” refers to measurement data acquired from one or more measurement devices or sensors, including raw and preprocessed readings such as water level values, ground movement values, tilt angles, acceleration values, and seismic waveform samples, each associated with time information and, optionally, position information.

The term “measurement device” refers to any physical sensing apparatus configured to measure a physical quantity related to natural phenomena, including but not limited to weather sensors, water level gauges, ground displacement sensors, tilt sensors, accelerometers, and seismometers.

The term “integrated data” refers to a structured data set obtained by temporally and spatially aligning heterogeneous environmental information and observation information based on time information and position information, and by storing the aligned data in data structures optimized for time-series and geospatial access.

The term “feature data” refers to one or more values derived from environmental information and observation information through data processing operations such as cleaning, normalization, aggregation, and transformation, where the values are suitable for use as input variables to one or more prediction models.

The term “derived indicator” refers to a computed metric that summarizes or transforms one or more raw measurements or feature data, such as cumulative precipitation, rainfall intensity, water level rise rate, ground displacement trend, spectral energy in a frequency band, or a composite risk index.

The term “input data sequence” refers to an ordered collection of feature data and derived indicators associated with a specific region and a specific time interval, arranged in temporal order for use as input to a prediction model.

The term “training data set” refers to a collection of input data sequences and associated labels that indicate occurrence or non-occurrence of a natural disaster event and, optionally, an occurrence scale or severity, the collection being used for supervised training of a prediction model.

The term “prediction model” refers to a computational model generated by a statistical learning method or a deep learning method that is configured to receive an input data sequence and to output at least one of an occurrence probability, a risk indicator, a danger level, and a predicted severity for a natural disaster event.

The term “statistical learning method” refers to a class of algorithms that estimate model parameters from data by optimizing a statistical objective function, including but not limited to regression, classification, decision tree, ensemble, and probabilistic modeling techniques.

The term “deep learning method” refers to a class of machine learning techniques that use multi-layer neural network architectures, including but not limited to feed-forward networks, convolutional networks, and recurrent networks, to learn complex relationships between input data and target outputs.

The term “model management area” refers to a storage region, such as a database, file system, or repository, configured to store one or more prediction models together with associated metadata, including training configurations, evaluation metrics, version identifiers, and deployment status.

The term “occurrence probability” refers to a numerical value output by a prediction model that represents a likelihood that a specified type of natural disaster will occur within a specified region and time interval.

The term “risk indicator” refers to a numerical or categorical value computed from model outputs and, optionally, additional data, that expresses the level of potential impact or hazard associated with a predicted natural disaster.

The term “danger level” refers to a categorized representation of risk for a particular region and time interval, determined based on at least one of an occurrence probability, a risk indicator, and one or more thresholds, and including, for example, levels such as low, medium, high, and very high.

The term “time information” refers to data that identifies a time point or time interval associated with environmental information or observation information, including timestamps and time ranges.

The term “position information” refers to data that identifies a geographic location associated with environmental information or observation information, including coordinates, region identifiers, and area polygons.

The term “generative AI model” refers to a machine learning model configured to generate information such as text, code, or structured data in response to an input, including but not limited to generative language models trained to output natural language or pseudo-code.

The term “prompt sentence” refers to structured input data, typically expressed as one or more natural language sentences and, optionally, associated structured information, provided to a generative AI model to specify a task, context, constraints, and desired output characteristics.

The term “proposal information” refers to data output by a generative AI model in response to a prompt sentence, the data including at least one of a feature generation method, a model configuration, a threshold setting, a training condition, and a warning text draft.

The term “feature generation method” refers to a procedure or algorithm for computing feature data from raw or preprocessed environmental information and observation information, including definitions of transformations, aggregations, and temporal or spatial combinations.

The term “model configuration” refers to information specifying structural and operational aspects of a prediction model, including but not limited to model type, architecture, hyperparameters, training settings, and input-output formats.

The term “threshold setting” refers to a numerical or logical condition that defines boundaries for classification or decision-making based on model outputs, such as cut-off values for determining danger levels or for triggering warning generation.

The term “warning text draft” refers to a natural language text generated as a candidate warning message, including content describing a predicted natural disaster, affected regions, time frames, and recommended actions.

The term “warning data” refers to structured information representing a warning to be transmitted, including at least one of a type of natural disaster, a warning level, a target region, a time margin, a predicted occurrence time, a predicted influence range, and recommended actions.

The term “time margin” refers to a time interval between a current or reference time and a predicted occurrence time or threshold crossing time for a natural disaster event, indicating a remaining time available for preparations or countermeasures.

The term “predicted influence range” refers to a spatial extent or set of regions that are expected to be affected by a predicted natural disaster, as determined by a prediction model and, optionally, geospatial processing.

The term “machine-readable format” refers to an encoding of warning data suitable for processing by computing systems, including but not limited to structured data formats such as JavaScript Object Notation, extensible markup language, and binary encodings.

The term “human-readable format” refers to an encoding of warning data as natural language text or graphics intended for direct interpretation by a human user.

The term “short message communication means” refers to a communication mechanism configured to transmit relatively short text-based messages, including text messaging services or similar short-text communication protocols.

The term “electronic document transmission means” refers to a communication mechanism configured to transmit electronic documents, including email systems and document messaging services.

The term “dedicated user terminal communication means” refers to a communication mechanism used to transmit warning data to computing devices running dedicated applications, including mobile terminals, tablet terminals, and personal computer terminals with installed client software.

The term “public warning distribution means” refers to a communication mechanism configured to disseminate warnings to a broad population, including broadcast systems, public alert gateways, and interfaces to governmental or municipal warning platforms.

The term “distribution history” refers to recorded information indicating when, how, and to which destinations warning data or warning texts were transmitted.

The term “delivery status” refers to recorded information indicating success, failure, or partial success of transmitting and, optionally, receiving warning data or warning texts at one or more destinations.

The term “warning reception confirmation information” refers to data transmitted from a user terminal indicating that a particular warning has been received, displayed, acknowledged, or otherwise processed by a user or device.

The term “on-site situation report information” refers to data transmitted from a user terminal describing conditions observed at a location, such as flooding level, landslide presence, or infrastructure damage, together with associated time information and, optionally, position information.

The term “auxiliary label” refers to a label derived from on-site situation report information or user feedback that is associated with integrated data and danger levels and used as additional supervision or correction information during model retraining or threshold adjustment.

The term “relearning” refers to a process of training or fine-tuning an existing prediction model using additional data, updated labels, or modified training conditions, while maintaining at least part of the model's previously learned parameters.

The term “danger level determination process” refers to a computation process that converts outputs of a prediction model, such as occurrence probabilities and risk indicators, into categorized danger levels using threshold settings and, optionally, temporal smoothing or logical constraints.

The term “warning text generation process” refers to a process that creates human-readable warning messages based on warning data, danger levels, and optionally outputs from a generative AI model, including selection, modification, and formatting of text for different communication channels.

The term “user attribute” refers to information describing characteristics of a user or a group of users, such as preferred language, region, role, or accessibility requirements, used to tailor warning texts and distribution methods.

The term “distribution media” refers to different communication channels or formats through which warning texts and warning data are transmitted, including short message communication channels, electronic document channels, dedicated terminal channels, and public broadcast channels.

The term “safety criteria” refers to predetermined rules or constraints ensuring that warning texts and warning data do not cause confusion, panic, misinformation, or unsafe actions, and that they comply with applicable regulatory or policy requirements.

The term “expression rule” refers to a predetermined guideline regarding wording, tone, length, structure, and level of technical detail for warning texts, used to standardize and validate generated warning messages.

In one embodiment, a server implements the claimed system as a network-connected computing device equipped with at least one processor, a memory, a non-transitory storage device, and communication interfaces. The server operates under a general-purpose operating system such as a server-class operating system and executes application software implemented, for example, in a programming language using data processing libraries such as numerical computation libraries and machine learning frameworks such as a tensor computation framework, a deep learning framework, and a statistical learning library. The server communicates over a packet-switched network, for example, the Internet, with external information sources and with terminals operated by users.

The server uses hardware resources including, for example, multi-core central processing units and optional graphics processing units. The server stores environmental information and observation information in a relational database management system such as a structured query language database or in a time-series optimized database. The server stores large gridded data files and image data in an object storage system. These concrete storage components and processing libraries enable the server to perform high-throughput and low-latency numeric computations on multi-dimensional arrays, which is difficult to achieve with manual or ad hoc processing.

The server acquires environmental information from external information sources that provide, for example, meteorological data, remote sensing data, and geospatial data via application programming interfaces. The server sends hypertext transfer protocol secure requests at configurable intervals to these external information sources and receives structured responses, such as JavaScript Object Notation or extensible markup language documents, that contain time-stamped and geo-referenced measurements of precipitation, cloud cover, wind fields, atmospheric pressure, surface temperature, river basin identifiers, and other environmental variables. The server parses these responses using parsing libraries and inserts the extracted values into normalized tables. Each table entry contains at least a time field, a geographic coordinate field or region identifier, a variable type field, and a numerical value field.

The server also receives observation information from measurement devices, such as water level gauges, ground displacement sensors, tilt sensors, accelerometers, and seismometers, via streaming protocols. The server subscribes to message queues or publish/subscribe topics exposed by gateway devices, decodes incoming binary or textual messages into internal record structures, and stores the observation information in time-series tables. Seismic waveform samples are stored as sequences of numeric values in array fields, together with sampling rates and channel identifiers. Ground displacement and tilt data are stored with sensor identifiers and installation coordinates. By representing waveform data as contiguous numeric arrays and by storing scalar sensor readings in indexed tables, the server reduces the overhead of random disk access and improves cache locality for subsequent vectorized processing operations.

The server performs quality control and integration of the environmental information and observation information in a way that changes the operation of the underlying computing system.

The server maintains for each sensor type a set of physical constraints, such as plausible minimum and maximum values and maximum gradients per unit time, and a set of logical constraints, such as cross-variable consistency rules between precipitation and water level or between rainfall intensity and landslide sensor movement. The server applies these constraints in vectorized form across batches of records using numeric computation libraries. Records that violate physical constraints are marked with a quality flag and are either discarded or replaced by interpolated values. Records that violate logical constraints trigger creation of derived flags that are stored alongside the numeric values. The use of vectorized constraint checking and flagging reduces the number of branching operations and avoids repeated database queries, which improves throughput and reduces processing latency compared with naive row-by-row validation.

The server aligns heterogeneous data streams into integrated data structures optimized for time-series and geospatial computation. The server defines a time grid according to a fixed step length, such as 5 minutes or 10 minutes, and a region grid that partitions the monitored area into polygonal regions derived from a geographic information system dataset. The server associates each sensor and each grid point with one or more regions using spatial join operations. The server then aggregates environmental information and observation information into per-region, per-time-slot records. Each record contains not only raw values but also precomputed statistics, such as sums, averages, maxima, minima, differences, and cumulative values over sliding windows of various lengths.

The server uses specific data structures, such as dense matrices organized as [time, region, feature] arrays, to hold feature data. Each feature index in the array corresponds to a defined metric, for example, accumulated precipitation over the past 6 hours, current water level, water level rise rate, three-component ground displacement vector, seismic spectral energy in specified frequency bands, and wind shear index. By arranging data in contiguous multi-dimensional arrays, the server enables efficient use of single instruction multiple data operations and reduces memory fragmentation. This structured representation differs from human inspection of scattered sensor logs and improves both memory access efficiency and computational throughput.

The server constructs prediction models using supervised learning methods that are explicitly disclosed. In one embodiment, the server uses a gradient boosting decision tree model implemented in a statistical learning library. The server feeds to the model training function the integrated per-region, per-time-slot features as inputs and labels that indicate whether a particular type of natural disaster, such as flooding, landslide, or significant seismic event, occurred in that region within a specified prediction horizon. The server defines a loss function, such as a logistic loss for binary classification or a cross-entropy loss for multi-class classification, and configures hyperparameters such as learning rate, maximum tree depth, number of trees, and minimum child weight. The server executes the training algorithm, which iteratively builds decision trees that fit residual errors, and updates the model parameters accordingly.

In another embodiment, the server uses a deep neural network as the prediction model. For example, the server constructs a temporal convolutional network with multiple one-dimensional convolutional layers that process the time dimension of the feature sequences. The network may include a sequence input layer, convolutional layers with rectified linear unit activations, pooling layers, and fully connected layers that output class logits. The server trains this network using a mini-batch gradient descent algorithm with an optimizer such as Adam. The server computes a loss function for each mini-batch, computes gradients of the loss with respect to network parameters by backpropagation, and updates the parameters according to the optimizer update rule. The server may also apply regularization techniques, such as dropout layers or L2 weight decay, and data augmentation strategies, such as adding noise within physically plausible ranges to training samples, to improve generalization. These details clarify that the system does not merely invoke an abstract “model decision” but rather implements specific, disclosed neural network architectures and optimization schemes that modify numeric parameters stored in memory.

The server registers trained prediction models in a model management area implemented as a database table and a corresponding file store. For each model version, the server stores a model identifier, a file path or object key to the stored model parameters, training configuration parameters, and evaluation metrics such as receiver operating characteristic area under the curve, Brier score, and calibration error. The server uses these stored metrics to control which model versions are eligible for on-line inference. By explicitly storing performance metadata and by enforcing selection rules based on these metrics, the server improves numerical stability and prediction accuracy over time without manual intervention.

The server interacts with a generative AI model using well-defined prompt sentences. The server generates a prompt sentence by converting current internal state information into natural language and simple structured descriptions. For example, the server may assemble a prompt sentence such as:

“Using multi-source data including rainfall, river levels, and landslide sensor readings, propose a feature engineering strategy and model architecture to improve early flood and landslide risk prediction in small river basins. Current model A achieves ROC-AUC 0.82 and frequently underestimates rapid-onset events under high rainfall intensity and steep river level rise conditions.”

In another example, the server may generate a prompt sentence:

“Based on recent misclassification cases where floods were not predicted despite cumulative 6-hour rainfall above threshold and river level rise rate above threshold, suggest additional temporal features, interaction terms, or non-linear transformations that can improve classification of these edge cases.”

The server sends such prompt sentences as plain text to the generative AI model, for example, via an application programming interface exposed by a remote computation service, and receives textual output. The server parses the output to identify concrete algorithmic proposals, such as new features (“ratio of 3-hour to 24-hour rainfall”), new architectures (“add a recurrent layer to capture temporal dependencies beyond 24 hours”), or new threshold relations (“increase flood alert probability when water level rise rate remains above a specified slope for more than N time steps even if absolute level is below critical”). The server converts these proposals into candidate configurations by modifying feature computation definitions, neural network layer specifications, or threshold tables stored in configuration files.

This generative AI interaction is not used merely to draft human-readable text; it is used to systematically alter code paths and numeric conditions inside the running system. The server automatically executes controlled experiments in which it trains alternative models or applies alternative thresholds defined by the proposal information, computes evaluation metrics on validation datasets, and compares these metrics against baseline metrics. Only when the proposal-based configuration demonstrates improvement according to defined criteria does the server register the configuration in the model management area. This closed-loop mechanism allows the server to search a larger space of model and feature configurations than would be feasible through manual tuning, leading to improved prediction accuracy and calibration, and thereby improves the operation of the computing system as a whole.

The server also uses the generative AI model to generate or refine warning texts based on structured warning data and danger levels. For example, when the server has computed a high flood danger level in a particular region, with a predicted time margin and predicted influence range, the server may construct a prompt sentence such as:

“Generate a clear and concise public flood warning message for Region A, where the flood danger level is ‘high’, the predicted occurrence time window is from 18:00 to 21:00 local time, and the expected impact area includes low-lying residential zones near the main river. Use calm but urgent tone and include at least one recommended protective action.”

The server provides the prompt sentence together with structured parameters to the generative AI model and receives candidate warning texts. The server then applies deterministic validation rules to these candidate texts, such as checking for prohibited phrases, enforcing maximum length for specific distribution channels, and verifying that at least one recommended action from a predefined set appears in the text. The server selects or modifies the candidate text accordingly and stores the resulting warning text for transmission. This procedure reduces variance in human-authored messages, ensures compliance with expression rules, and adapts messages to different media constraints, thereby improving communication effectiveness. From a computer-technology perspective, the server implements a non-trivial pipeline that converts internal numeric state into verified natural language outputs through programmatic control of a generative AI model, rather than relying on static message templates.

In another embodiment, the server generates different warning texts for different user attributes and distribution media. For example, the server may generate a shorter, more directive message for short message communication means, and a longer, more explanatory message for electronic document transmission means. The server maintains mapping rules from danger levels and user attributes to preferred message styles and length limits, and these mapping rules are applied to the outputs received from the generative AI model. This separation of style control from base warning content allows the server to reduce duplicate template definitions and to manage warning text generation in a more modular and maintainable manner.

The server distributes warning data to terminals through various communication channels. The server encodes machine-readable warning payloads in structured formats and sends them via push notification services or via representational state transfer application programming interfaces to terminal applications. These payloads include identifiers for the warning event, numeric danger levels, timestamps, and recommended actions encoded as enumerated values. By sending structured payloads rather than free text alone, the server enables terminals to perform local filtering, prioritization, and visualization computing that reduces bandwidth consumption and distributes processing load.

The terminal implements a client application that runs, for example, on a mobile computing device or a fixed display unit. The terminal periodically contacts the server or listens for push notifications to receive warning data. The terminal parses the machine-readable warning data, maps region identifiers to local map views, and renders icons and color-coded overlays on a digital map. The terminal uses user attributes such as preferred language and accessibility settings to select appropriate warning texts, which may be pre-generated or customized. The terminal stores recently received warning data in local storage to support offline access. By performing these rendering and filtering operations on the terminal side, the system reduces repeated queries to the server and allows the server to focus on high-volume data processing tasks.

The user interacts with the terminal by configuring personal settings, such as location of interest, disaster types of interest, and notification preferences. The user may also submit on-site situation report information via the terminal interface. For example, the user may select an incident type from a list (e.g., “river overflowing bank”, “minor landslide blocking road”), attach optional images, and send the report. The terminal encodes this information as structured data with a timestamp and position information and transmits it to the server via a secure channel.

The server receives on-site situation report information and correlates it with the integrated data and the computed danger levels. For example, the server links a report of actual flooding at a given time and location with the corresponding model outputs and sensor readings at that time and location. The server stores this correlation as an auxiliary label, indicating, for example, that flooding occurred even though the model output had a medium danger level and a moderate occurrence probability. During subsequent retraining, the server incorporates these auxiliary labels into the training data set to adjust model weights and thresholds. This feedback-driven correction mechanism systematically reduces prediction bias and refines calibration, achieving improved alignment between model predictions and real-world outcomes. The process implements algorithmic adjustments at the level of numeric weights and thresholds rather than relying on manual rewriting of rules.

The described embodiments also improve computer technology by optimizing data management and reducing communication load. The server avoids repeatedly transmitting full-resolution sensor data to terminals. Instead, the server processes and aggregates raw data into compact derived indicators and danger levels. This approach significantly reduces the volume of data that must be transmitted over wide-area networks and reduces the energy consumption of both server and terminal devices. Furthermore, by representing high-frequency waveform data in fixed-length array segments and by performing spectral analysis using fast Fourier transform routines, the server improves computational efficiency relative to naive per-sample processing.

In alternative embodiments, the server may adopt different model architectures. For example, for seismic early warning, the server may implement a recurrent neural network such as a long short-term memory network that processes waveform-derived features over time. The network may have an input layer of dimension corresponding to band-limited spectral amplitudes, one or more recurrent layers that model temporal dependencies, and an output layer that estimates the probability of a significant event occurring in the next time window. The server trains this network using a binary cross-entropy loss function and updates its parameters with gradient-based optimization. For landslide prediction, the server may implement a graph-based neural network that captures dependencies between adjacent slope units. These variations demonstrate that the invention encompasses multiple concrete, non-abstract model implementations that operate on the integrated data structures.

The server may also employ alternative generative AI models, such as encoder-decoder architectures, but in all cases the server constructs explicit prompt sentences that describe system state in terms of features, metrics, and misclassification patterns. The server then parses generated text into structured instructions for changing code and configuration. This pattern, in which a generative AI model is embedded inside a closed-loop optimization mechanism under strict programmatic control, differentiates the present system from traditional systems in which human experts manually interpret model outputs and manually rewrite code.

By combining these components—integrated data structures, explicitly defined prediction models, structured prompt sentences for a generative AI model, and feedback from user reports—the system advances the technical field of computer-implemented prediction and alerting. The server performs coordinated data transformations, learning algorithms, and controlled generative AI interactions that together improve prediction precision, reduce false alarms, lower end-to-end latency, and reduce communication load. The terminal translates these improved predictions into actionable information for users in real environments. The resultant arrangement is not a mere automation of human reasoning, but rather introduces specific data structures, algorithms, and control flows that enhance the functioning of the computing system itself.

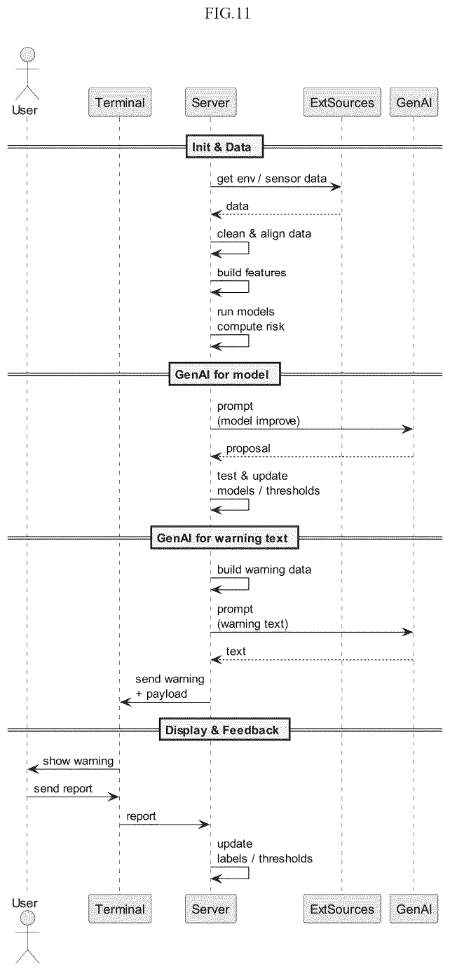

The following describes the processing flow using FIG. 11.

### Step 1:

Server initializes configuration and data structures.

Server receives as input one or more configuration files specifying external information sources, sensor identifiers, region definitions, time-grid parameters, model versions, and communication settings.

Server parses the configuration files, validates parameter ranges, and loads region polygons and sensor metadata into memory.

Server constructs internal data structures, such as region lookup tables, time-grid definitions, and empty multi-dimensional arrays [time, region, feature] to hold feature data.

Server outputs initialized in-memory structures and validated configuration parameters that are used as inputs to subsequent steps.

### Step 2:

Server acquires environmental information from external information sources.

Server receives as input endpoint addresses, authentication tokens, and query parameters for each external information source.

Server sends periodic secure requests to those endpoints and receives structured responses containing time-stamped and geo-referenced environmental measurements, such as rainfall intensity, temperature, wind speed, and atmospheric pressure.

Server parses each response, converts units if necessary, and maps raw fields to internal variable identifiers.

Server outputs normalized environmental records, each record including at least a timestamp, a location identifier, a variable type, and a numeric value, and stores the records in a database and in a short-term in-memory buffer.

### Step 3:

Server acquires observation information from measurement devices.

Server receives as input streaming messages from measurement devices, such as water level gauges, ground displacement sensors, and seismometers, via messaging protocols.

Server decodes each incoming message into a structured record containing a sensor identifier, a timestamp, optional position information, and one or more measurement values (e.g., water level, displacement, waveform samples).

Server groups high-frequency waveform samples into fixed-length numeric arrays and attaches sampling rates and channel identifiers.

Server outputs structured observation records and waveform arrays, stores them in time-series tables, and places references to them into processing queues.

### Step 4:

Server performs data quality control on environmental and observation information.

Server receives as input normalized environmental records and structured observation records from Steps 2 and 3.

Server applies physical-constraint checks by comparing measurement values to sensor-specific minimum, maximum, and maximum gradient thresholds, and applies logical-constraint checks by comparing correlated variables, such as rainfall and water level rise rates.

Server labels records that violate constraints with quality flags, interpolates missing values using temporal interpolation for scalar variables, and replaces short gaps in waveform data by interpolation or marking unusable segments.

Server outputs cleaned environmental and observation records, where each record includes quality flags and any corrected values, and stores these in quality-controlled tables.

### Step 5:

Server aligns data in time and assigns data to regions.

Server receives as input cleaned environmental and observation records, region definitions, and time-grid parameters.

Server maps each record to a discrete time slot based on its timestamp and to one or more region identifiers based on its location coordinates and region polygons.

Server aggregates measurements within each region and time slot, computing statistics such as mean rainfall, cumulative rainfall over the slot, average wind speed, and mean water level.

Server outputs region-time aggregated records, each identified by a region identifier and time slot and containing aggregated raw values, and stores these in an intermediate region-time table.

### Step 6:

Server computes derived indicators and feature data.

Server receives as input the region-time aggregated records from Step 5 and historical context windows.

Server computes derived indicators such as multi-hour cumulative rainfall, water level rise rates (difference divided by time), ground displacement trends (slope of displacement over time windows), and spectral energy in specific frequency bands from waveform arrays.

Server normalizes and scales these indicators according to pre-defined parameter sets, for example by subtracting means and dividing by standard deviations stored in configuration.

Server outputs per-region, per-time-slot feature vectors, and writes them into a feature store as dense arrays indexed by (time, region, feature index).

### Step 7:

Server constructs training data sets from historical data.

Server receives as input historical feature vectors, historical labels indicating occurrence or non-occurrence and severity of past natural disasters, and selection criteria for training, validation, and test periods.

Server merges feature vectors with labels by matching region identifiers and prediction horizons, and discards samples lacking sufficient historical context.

Server partitions the merged records into training, validation, and test subsets according to defined time ranges and region groups, and stores the result in dedicated training data tables.

Server outputs structured training data sets that provide labeled input-output pairs for model training.

### Step 8:

Server trains prediction models using supervised learning.

Server receives as input training data sets from Step 7 and model configuration parameters specifying model type, architecture, and hyperparameters.

Server loads feature matrices and labels into memory, initializes model parameters (e.g., tree structures for gradient boosting or weights for neural networks), and executes an optimization algorithm that iteratively updates the parameters to minimize a loss function such as cross-entropy.

Server evaluates model performance on the validation subset, computing metrics such as accuracy, ROC-AUC, Brier score, and calibration error, and may adjust hyperparameters according to predefined search strategies.

Server outputs trained model parameters and performance metrics and registers them as model versions in the model management area.

### Step 9:

Server selects an active prediction model for operational use.

Server receives as input the registered model versions and their associated evaluation metrics.

Server applies selection rules, such as choosing the most recent model that meets minimum thresholds for ROC-AUC and calibration, or choosing a model with the lowest validation loss among eligible models.

Server stores the identifier and configuration of the selected active model in a runtime configuration store.

Server outputs a reference to the active prediction model, which subsequent online prediction steps use as an input.

### Step 10:

Server executes real-time prediction using the active model.

Server receives as input the latest feature vectors from Step 6 and the active model reference from Step 9.

Server loads the active model into memory and performs inference by feeding each region-time feature vector through the model, computing for each region and natural disaster type at least an occurrence probability and possibly a predicted severity.

Server optionally smooths probabilities over time windows and applies numeric constraints to avoid abrupt oscillations, such as limiting rate-of-change for danger levels.

Server outputs per-region prediction results, including probabilities, risk indicators, and preliminary danger levels, and records these outputs in a prediction results table.

### Step 11:

Server determines final danger levels from model outputs.

Server receives as input per-region prediction results and threshold configurations specifying boundaries for danger levels.

Server compares occurrence probabilities and risk indicators against the thresholds, applies combination rules (for example, prioritizing higher severity events when multiple event types are present), and assigns discrete danger levels such as low, medium, high, and very high for each region and disaster type.

Server may refine danger levels by examining persistence over consecutive time slots and increasing levels for sustained high risk.

Server outputs finalized danger level assignments per region and stores these in a danger level table.

### Step 12:

Server generates prompt sentences for generative AI-based model improvement.

Server receives as input current model performance metrics, logs of misclassification cases, and summaries of feature configurations.

Server constructs a prompt sentence that describes, in natural language, the current model architecture, observed failure patterns, and desired improvement goals, for example: “Using multi-source data including rainfall, river levels, and landslide sensor readings, propose a feature engineering strategy and model architecture to improve early flood and landslide risk prediction in small river basins. Current model achieves ROC-AUC 0.82 and underestimates rapid-onset events under high rainfall intensity and steep river level rise conditions.”

Server outputs the prompt sentence as a text string ready to be sent to a generative AI model.

### Step 13:

Server interacts with the generative AI model to obtain proposal information.

Server receives as input the prompt sentence from Step 12 and, optionally, encoded descriptions of feature sets or threshold tables.

Server sends the prompt sentence to the generative AI model through an application programming interface and receives a textual response that includes proposed new features, model architecture modifications, training strategies, or threshold adjustments.

Server parses the response into structured proposal information, such as a list of derived feature formulas or specific architecture changes, and stores this proposal information in a configuration candidate repository.

Server outputs the parsed proposal information for use in experimentation and potential system updates.

### Step 14:

Server evaluates proposal-based configurations and updates models and logic.

Server receives as input the proposal information from Step 13 and the baseline model configuration and performance metrics.

Server creates multiple experimental configurations by applying proposed changes to feature definitions, model architecture parameters, or threshold values, and retrains corresponding models using the same historical training data as the baseline.

Server computes evaluation metrics for each experimental model, compares them against baseline metrics according to predefined improvement criteria, and selects configurations that demonstrate statistically significant improvements.

Server outputs updated prediction models, updated threshold configurations, or updated danger level determination rules, and registers the selected configurations in the model management area for subsequent use.

### Step 15:

Server generates structured warning data from danger levels.

Server receives as input the finalized danger levels from Step 11, predicted occurrence times derived from model outputs, and predicted influence ranges from geospatial processing.

Server constructs warning records that, for each affected region and disaster type, include a warning level, a time margin until predicted event onset, an influence range descriptor, and a set of recommended actions selected from an action catalog.

Server converts these warning records into a machine-readable structure, assigning identifiers, timestamps, and channel preferences, and also prepares initial human-readable templates that summarize the structured information.

Server outputs structured warning data objects that can be further processed for text generation and distribution.

### Step 16:

Server generates and validates warning texts using a generative AI model.

Server receives as input the structured warning data objects from Step 15 and text generation configurations specifying tone, length constraints, and language.

Server constructs a prompt sentence for each warning that embeds key parameters, for example: “Generate a clear and concise public flood warning message for Region A, where the flood danger level is ‘high’, the predicted occurrence time window is from 18:00 to 21:00 local time, and the expected impact area includes low-lying residential zones near the main river. Use calm but urgent tone and include at least one recommended protective action.”

Server sends each prompt sentence to the generative AI model, receives candidate warning texts, and applies validation rules that check for prohibited words, required action phrases, and length limits.

Server outputs validated warning texts associated with each structured warning data object and stores them for distribution.

### Step 17:

Server distributes warning data and warning texts to terminals and external channels.

Server receives as input validated warning texts and corresponding structured warning data, as well as subscription information for terminals and external systems.

Server formats messages according to target channels, such as short text content for short message communication means and richer content for electronic document transmission means, and attaches relevant machine-readable payloads.

Server sends these formatted messages through network interfaces to push notification services, messaging gateways, and public alert interfaces, and logs distribution results including timestamps and confirmation codes.

Server outputs delivery records and updated distribution history entries.

### Step 18:

Terminal receives, processes, and displays warning information.

Terminal receives as input warning messages and machine-readable payloads sent by the server in Step 17.

Terminal verifies message authenticity when applicable, parses the payload to extract danger levels, disaster types, time margins, and recommended actions, and stores the parsed data in local storage for offline access.

Terminal maps danger levels to visual indicators such as colors and icons on a map, and presents the associated warning text in the user's preferred language, optionally adjusting font size or layout based on user settings.

Terminal outputs a user-visible display of current warnings and updates the display when new or modified warnings arrive.

### Step 19:

User configures preferences and submits on-site situation reports.

User receives as input the warning information shown on the terminal in Step 18 and interacts with the terminal interface.

User sets preferences such as geographic areas of interest, types of disasters to monitor, and notification methods, and provides on-site reports by selecting event categories and optionally entering free-text comments or attaching media.

User submits the configuration changes and on-site reports through the terminal application, which packages them into structured messages containing user identifiers, timestamps, position information, and report content.

User outputs user-generated configuration updates and situation report messages that are transmitted from the terminal to the server.

### Step 20:

Server ingests user feedback and refines training data and thresholds.

Server receives as input structured configuration updates and on-site situation report messages from terminals as produced in Step 19.

Server updates user-specific subscription and filtering rules based on configuration updates, and correlates situation reports with corresponding regions, time slots, and model outputs by matching timestamps and positions.

Server converts correlated situation reports into auxiliary labels indicating, for example, confirmed occurrence or non-occurrence of certain events, and appends these labels to the historical training data or uses them to adjust thresholds for danger levels in specific regions.

Server outputs updated training data sets and updated threshold configurations, which are then available as inputs for future retraining and recalibration processes.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional disaster prediction and alert systems typically rely on static rule sets and predesigned machine learning models that are manually configured and infrequently updated. Such systems suffer from several technical limitations. First, heterogeneous sensor streams and environmental data (for example, data from transportation, power, water, and communication infrastructures) are often processed in siloed pipelines without unified temporal and spatial integration, resulting in loss of contextual information and reduced prediction accuracy. Second, existing systems generally employ fixed data preprocessing logic and model configurations that are not dynamically adapted to changes in data characteristics, such as sensor failures, distribution shifts, or newly emerging patterns of natural disasters. This rigidity leads to degraded model performance over time and requires costly human intervention to redesign feature extraction, model architectures, and thresholds.

Third, many systems do not exploit feedback from end-user devices, such as status reports and real-time observations from mobile terminals, as machine-processable input for updating risk assessments and alert policies. As a result, system responsiveness and situational awareness are limited, and the system cannot effectively reconcile discrepancies between sensor readings and on-the-ground conditions.

Fourth, the integration of generative AI models into operational decision flows is either absent or ad hoc. Even when generative AI is used, its outputs are not systematically incorporated to reconfigure data pipelines, adjust thresholds, or re-prioritize evacuation strategies in a closed feedback loop. Consequently, the system cannot automatically refine its own computational procedures in response to evolving scenarios, and the benefits of generative AI are not realized as concrete improvements in model performance and alert quality.

Accordingly, there is a need for a technical solution that improves computer technology in this field by: (i) implementing a unified spatiotemporal integration and preprocessing framework for multi-modal observation information, (ii) dynamically adapting discrimination and prediction models and their parameters based on suggestions obtained from a generative AI model, and (iii) feeding back user-side observation and status information from mobile terminals into the core inference pipeline. Such a solution should provide a concrete, computer-implemented mechanism by which the system automatically revises its feature sets, model configurations, thresholds, and alert-generation conditions, thereby improving the accuracy, robustness, and timeliness of disaster impact prediction and alert delivery while reducing the need for manual system redesign.

The specific processing by the specific processing unit 290 of the data processing device 12 in Application Example 1 is realized by the following means.

The present invention provides a server comprising a processor and a memory storing instructions which, when executed by the processor, cause the processor to acquire environmental information and observation information from multiple data sources, to integrate the acquired information based on temporal information and spatial information, and to perform preprocessing including outlier removal and missing-value completion on the integrated information, to apply a learned discrimination model or prediction model to the preprocessed information so as to extract feature values related to a natural event and to evaluate a probability of occurrence of a natural disaster, to calculate, based on a result of the evaluation, an influence degree and an influence range of the natural disaster on an infrastructure and to generate risk indicators for at least a road network, a power system, a water supply system, and a communication network, to generate and transmit a prompt sentence to a generative AI model by using the evaluation result and the risk indicators as input information, to receive response information relating to an analysis method, a prediction method, or a control policy from the generative AI model, and to automatically or semi-automatically update, based on the response information, at least one of (i) a configuration of feature values used by the discrimination model or prediction model, (ii) threshold values and rules used in the calculation of the influence degree and the influence range, and (iii) conditions for generation of an alert, to generate alert information based on the calculated influence degree and the calculated influence range, the alert information including at least a type, a scale, and an expected occurrence time of the natural disaster, an estimated affected area, and an evacuation route or a detour route, and to distribute the alert information to multiple client devices and public alert devices via a plurality of communication paths and to receive, from a mobile terminal application executed on at least one of the client devices, response information including disaster-status report information or route passability information and to incorporate the response information as additional input into subsequent evaluations and influence calculations. This enables a computer-implemented disaster management system in which the core data processing pipeline and model behavior are dynamically and automatically refined in response to evolving observation data and generative AI guidance, thereby improving the technical performance of risk estimation, impact prediction, and alert generation, enhancing robustness against data variability and sensor anomalies, and reducing manual intervention in system reconfiguration.

The term “environmental information” refers to information indicative of environmental conditions, including at least weather-related data such as temperature, precipitation, wind, atmospheric pressure, and forecast data obtained from external information sources.

The term “observation information” refers to information acquired from one or more observation devices, including at least measurements from sensing devices associated with transportation, power, water, and communication infrastructures.

The term “temporal information” refers to information indicative of time, including at least timestamps or time intervals associated with environmental information and observation information, used to align data on a time axis.

The term “spatial information” refers to information indicative of location, including at least coordinates, region identifiers, or other geographic indicators associated with environmental information and observation information, used to align data on a spatial axis.

The term “preprocessing” refers to computer-implemented operations performed on acquired data prior to model evaluation, including at least outlier removal, missing-value completion, data normalization, and aggregation.

The term “outlier removal” refers to a process in which data values that deviate from an expected range or pattern are detected and removed or corrected according to a predetermined criterion.

The term “missing-value completion” refers to a process in which absence of data at expected temporal or spatial positions is detected and supplemented with estimated values determined by an interpolation method or a model-based method.

The term “discrimination model” refers to a computational model, implemented in software or hardware, that classifies input data into one of multiple classes, including at least models used to determine whether a natural disaster is likely to occur.

The term “prediction model” refers to a computational model, implemented in software or hardware, that outputs a predicted value or distribution for a future state of a system, including at least models used to estimate the probability of occurrence or severity of a natural disaster.

The term “feature value” refers to a numerical or categorical quantity derived from environmental information and observation information and used as an input variable for a discrimination model or prediction model.

The term “natural event” refers to a physical phenomenon in a natural environment, including at least weather events, hydrological events, and geological events, which may lead to a natural disaster.

The term “natural disaster” refers to an event caused by a natural phenomenon that threatens or damages human life, property, or infrastructure, including at least floods, storms, landslides, and related large-scale events.

The term “infrastructure” refers to physical or virtual structures and systems that support social and economic activities, including at least a road network, a power system, a water supply system, and a communication network.

The term “influence degree” refers to a quantitative indicator representing an extent or severity of impact that a natural disaster is expected to have on an infrastructure.

The term “influence range” refers to a spatial and temporal scope within which a natural disaster is expected to affect an infrastructure, including at least a geographic area and a time period.

The term “risk indicator” refers to a numerical or categorical value representing a level of risk of damage or disruption for a particular infrastructure, computed based on evaluation results from a discrimination model or prediction model.

The term “road network” refers to a set of interconnected road segments, intersections, and related facilities used for vehicular or pedestrian traffic within a geographic area.

The term “power system” refers to a system configured to generate, transmit, distribute, and supply electric power, including at least substations, transmission lines, distribution lines, and associated control equipment.

The term “water supply system” refers to a system configured to store, treat, and distribute water for consumption or industrial use, including at least reservoirs, pipelines, pumps, and water treatment facilities.

The term “communication network” refers to a network configured to transmit information signals between endpoints, including at least wired and wireless communication links, communication nodes, and network control devices.

The term “generative AI model” refers to a machine learning model configured to generate output information such as text, code, or structured data in response to an input, including at least models that produce proposals regarding analysis methods, prediction methods, or control policies.

The term “prompt sentence” refers to textual information provided to a generative AI model as an input instruction, including at least a description of available data, desired outputs, constraints, or target natural disaster types.

The term “response information” refers to information output by a generative AI model in response to a prompt sentence, including at least proposals regarding feature extraction methods, model configurations, threshold setting methods, evaluation indices, analysis methods, prediction methods, or control policies.

The term “analysis method” refers to a procedure or algorithm for processing and interpreting environmental information and observation information, including at least methods for feature extraction, pattern recognition, and anomaly detection.

The term “prediction method” refers to a procedure or algorithm for estimating a future state or probability of an event based on input data, including at least methods for forecasting occurrence or impact of a natural disaster.

The term “control policy” refers to a rule set or decision logic that determines how to adjust system parameters, alert thresholds, or evacuation priorities in response to evaluation results or prediction results.

The term “alert information” refers to information generated by the system to notify stakeholders and residents of a predicted natural disaster, including at least a type, a scale, an expected occurrence time, an estimated affected area, and an evacuation route or a detour route.

The term “evacuation route” refers to a path or sequence of paths designated for movement of persons from a hazardous area to a safer area.

The term “detour route” refers to a path or sequence of paths designated to avoid an area predicted to be hazardous or inaccessible due to a natural disaster.

The term “stakeholder” refers to an entity that is responsible for or affected by disaster management operations, including at least governmental agencies, emergency response organizations, and infrastructure operators.

The term “client device” refers to an electronic device operated by a user and configured to communicate with the server, including at least mobile terminals, portable information terminals, and fixed terminals.

The term “mobile terminal” refers to a portable client device capable of wireless communication, including at least a smartphone, a tablet terminal, or a similar device.

The term “mobile terminal application” refers to a software program executed on a mobile terminal and configured to receive alert information, display guidance, and transmit response information.

The term “public alert device” refers to a device configured to provide public notifications, including at least electronic display boards, siren systems, and public address systems.

The term “response information” (from a mobile terminal) refers to information transmitted from a client device to the server after receipt of alert information, including at least disaster-status report information, route passability information, and user acknowledgment information.

The term “disaster-status report information” refers to information indicative of actual conditions in a target area during or before a natural disaster, including at least flooding conditions, road blockages, or infrastructure failures as observed by users.

The term “route passability information” refers to information indicating whether a particular route, road segment, or infrastructure element is currently passable, obstructed, or unsafe.

The term “evaluation result” refers to output data generated by a discrimination model or prediction model, including at least probabilities of occurrence of natural disasters and intermediate scores used to derive risk indicators.

The term “alert generation condition” refers to a logical condition or threshold that determines whether alert information is to be generated and distributed based on an evaluation result, an influence degree, an influence range, or a risk indicator.

In one embodiment, a server implements the claimed system as a network-connected computing apparatus including at least one processor, a main memory, a non-transitory storage medium, and communication interfaces. The server executes an operating system such as a general-purpose server operating system and runs middleware including a message broker such as a publish/subscribe communication component and a database management component such as a time-series database or a relational database. The server further executes application programs that implement environmental information acquisition, observation information acquisition, spatiotemporal integration, preprocessing, model-based evaluation, influence calculation, generative AI interaction using a generative AI model and a prompt sentence, alert generation, and alert distribution.

The server acquires environmental information from external information sources, such as weather information services and governmental data feeds, through a communication interface using network protocols including HTTP or HTTPS. The server acquires observation information from a plurality of observation devices deployed in a physical environment. The observation devices include sensors associated with transportation infrastructure, electric power infrastructure, water infrastructure, and communication infrastructure. For example, the server receives vehicle speed and vehicle count from roadway detectors, voltage and current from power monitoring devices, flow rate and water quality metrics from flow meters and water quality meters, and packet loss and latency from network monitoring devices. These data arrive at the server as streaming messages or periodic uploads in formats such as structured text or binary frames.

The server uses a time-series database to store the acquired environmental information and observation information. Each record is associated with temporal information such as a timestamp and spatial information such as a location identifier, a geographic coordinate, or a region identifier. The server represents the data using a structured schema whose fields include at least a sensor identifier, a measurement type, a measurement value, and a quality flag. The server maintains index structures on the temporal information and the spatial information to allow efficient retrieval of data segments corresponding to particular time intervals and regions.

The server performs preprocessing of the integrated information using specialized software libraries for numerical computation and data analysis. The server identifies outliers by applying a statistical test such as a z-score test or by using an outlier detection model such as an isolation forest model. The server removes or corrects the outliers by replacing them with interpolated values or model-estimated values. The server fills missing values by performing interpolation along the temporal axis or by using model-based imputation. In addition, the server performs normalization or standardization to align scales across different measurement types, and the server applies aggregation operations over specified temporal windows to compute features such as moving averages, cumulative sums, and maximum or minimum values. These preprocessing operations are implemented as deterministic dataflow modules that transform structured records into feature vectors suitable for input into learned models.

The server applies a discrimination model or a prediction model to the preprocessed information. In one embodiment, the discrimination model is a supervised learning model such as a gradient-boosted decision tree model trained to output a probability that a natural disaster event such as flooding, storm damage, or landslide will occur in a designated region during a future time interval. The prediction model may include a time-series neural network model such as a recurrent neural network or a long short-term memory network that receives a sequence of feature vectors over time and outputs a predicted future value such as river water level, power outage probability, or traffic congestion level.

The server trains these models offline using historical environmental information and observation information combined with historical labels representing actual occurrences of natural disasters. During training, the server defines a loss function such as a cross-entropy loss for classification or a mean squared error loss for regression. The server updates model parameters including weights and biases using an optimization algorithm such as stochastic gradient descent or a variant thereof. The server may perform data augmentation by adding noise to input features, resampling time windows, or creating synthetic sequences to improve model robustness. The server stores the trained models in a model repository in a serialized format and loads them into memory to execute inference operations.

The server calculates an influence degree and an influence range of a predicted natural disaster on multiple types of infrastructure using the output of the discrimination model or the prediction model. The server constructs a data structure that associates each region and each infrastructure type with a risk indicator, which may be a probability value or a severity score. For example, the server computes a flood risk indicator for each grid cell along a river, a power outage risk indicator for each distribution area, a road inundation risk indicator for each road segment, and a communication disruption risk indicator for each base station region. The server derives these indicators by combining predicted probabilities with vulnerability parameters, such as elevation, historical failure rates, and redundancy of alternative paths.

The server uses a generative AI model to improve the internal configuration of feature values, model parameters, thresholds, and alert-generation conditions. The generative AI model is a generative AI model that can receive a prompt sentence and output structured natural-language guidance. The server constructs a prompt sentence that includes a structured description of the current data characteristics, model performance metrics, and target natural disaster types. For example, the server may generate a prompt sentence such as:

“Show a method for predicting the occurrence of traffic congestion under specific weather conditions using data from traffic sensors, rainfall sensors, and historical congestion records.”

or

“Design an algorithm that evaluates the risk of power outage with high accuracy based on time-series voltage, current, and frequency data from power sensors, combined with wind speed and precipitation forecasts.”

The server transmits the prompt sentence to the generative AI model via a network interface and receives response information that includes proposed feature extraction methods, suggestions for model architectures, or rules for threshold setting. The server parses the response information, identifies actionable elements such as “use cumulative rainfall over the past 6 hours” or “apply a two-stage model with anomaly detection followed by risk classification,” and updates its internal configuration. For instance, the server may add a new cumulative rainfall feature to the feature vector, modify the architecture of the neural network by changing the number of hidden units or layers, or adjust threshold values used for converting risk indicators into alert levels.

In this manner, the server does not merely automate a fixed set of human-designed rules. Instead, the server repeatedly refines the computational pipeline by integrating machine-generated proposals into a structured configuration and verifying the impact on predictive performance.

The server can automatically schedule offline experiments in which candidate configurations suggested by the generative AI model are tested on validation datasets. The server compares metrics such as prediction accuracy, false positive rate, and processing time, and the server selects configurations that achieve predefined performance criteria. The server then deploys the selected configuration for operational use.

The server generates alert information based on the calculated influence degree and the calculated influence range and the updated thresholds and alert-generation conditions. The alert information describes at least a type of natural disaster, a predicted scale, a predicted time of occurrence, an estimated affected area, and an evacuation route or a detour route. The server computes evacuation routes and detour routes by applying a graph search algorithm to a representation of the road network stored in a spatial database, taking into account road segments predicted to be inundated, blocked, or otherwise unsafe during a given time interval. This algorithmic route computation is performed automatically by the server based on the risk indicators and predicted hazard evolution, and is not a simple human selection of roads.

The server distributes the alert information to multiple terminals. The server sends notifications to mobile terminals such as smartphones and tablet devices using a push notification service. The server also sends alert messages to public alert devices such as electronic display boards or siren control systems through dedicated network channels. Each terminal executes an application program that receives alert information, displays a map and text description of the risk indicators, and offers user interface elements for the user to acknowledge the alert or to submit status information.

The user operates the terminal to view the alert information and to perform actions such as confirming an evacuation route. The user may input disaster-status report information, such as “road X is already flooded” or “bridge Y is still passable.” The terminal transmits this response information to the server. The server integrates the response information with sensor data, updating the risk indicators and possibly overriding or adjusting predictions if persistent discrepancies are detected. For example, if multiple users report that a road is impassable while sensors show normal traffic, the server may mark the road segment as blocked and recompute evacuation routes, thereby changing the alert information. This feedback loop improves the quality of the model inputs and, consequently, the accuracy of the predictions.

The technical effect of the described architecture is not limited to an abstract idea of “analyzing and displaying information.” The server implements specific data structures for multi-modal spatiotemporal data, uses non-conventional combinations of preprocessing and model adaptation driven by a generative AI model, and executes specialized computations that achieve concrete improvements in computing performance. Because the server dynamically updates model structures and feature sets based on response information from the generative AI model, the server can maintain or improve prediction accuracy under changing data distributions without requiring manual redesign for each new scenario. This reduces the need for static over-provisioning of features and thresholds and leads to a more compact and efficient model, resulting in improved processing speed and reduced memory consumption.

Moreover, the server can reduce unnecessary communication load and alert noise by optimizing thresholds and alert-generation conditions using the generative AI model's proposals. By automatically adjusting alert criteria to limit alerts to high-confidence events, the system can decrease redundant alert messages and thereby reduce communication traffic over public networks and user devices. The use of user-provided route passability information further allows the server to avoid repeatedly querying sensors or infrastructure systems where user reports already provide the required resolution, contributing to communication efficiency.

The system also improves data management by maintaining consistent spatiotemporal indices and quality flags and by storing evaluation results, influence calculations, and user feedback in a form suitable for incremental retraining of models. The server can perform incremental learning by re-training or fine-tuning a model using newly labeled data and updated feature sets, and the server can monitor loss functions over time to detect model drift. This feedback-driven learning approach is not a straightforward automation of human decision-making but uses a combination of learned models and generative AI-driven model design to adapt the internal workings of the computing system itself.

In another embodiment, the server may use a different type of neural network architecture, such as a temporal convolutional network or a transformer-based sequence model, as the prediction model. In this case, the server still constructs feature sequences from the preprocessed information and feeds them into the model, but the convolutional or attention-based layers compute representations of temporal patterns and spatial correlations. The server determines the number of layers, filter sizes, and attention heads by considering configuration suggestions from the generative AI model. The generative AI model may propose, for example, “use a temporal convolutional network with dilation factors 1, 2, and 4 for capturing short- and medium-term patterns in rainfall and river level,” and the server implements and tests such a configuration. In an alternative embodiment, the server may deploy multiple models in parallel, each specialized for a particular disaster type or infrastructure type, and may use the generative AI model to propose a meta-decision rule for combining their outputs. For instance, the server may maintain separate models for flood risk, landslide risk, and power outage risk, and may use a higher-level logic that weighs their outputs to determine overall evacuation priorities. The generative AI model may output guidance such as “prioritize evacuation for areas where flood risk and landslide risk are both above a threshold when road capacity is low,” and the server encodes this as a machine-executable rule that affects the computation of evacuation routes and alert content.

In another variation, the server may be distributed among multiple physical machines, each responsible for a subset of regions or a subset of data sources. The generative AI interaction may be centralized or replicated across nodes. Even in such distributed configurations, each node performs the same type of preprocessing, model-based evaluation, influence calculation, generative AI interaction, and alert generation steps, and each node contributes to a unified system that improves prediction accuracy and response time at a city scale.

Thus, by implementing specific data structures, algorithmic steps, and model adaptation mechanisms controlled by the server and guided by a generative AI model via a prompt sentence, the system realizes a technical improvement in computer-based disaster management. The server uses non-conventional processing flows that go beyond simple automation of human analysis, enabling higher-precision, lower-latency, and more resource-efficient prediction and alert functions that are tightly coupled to real-world infrastructure monitoring and control.

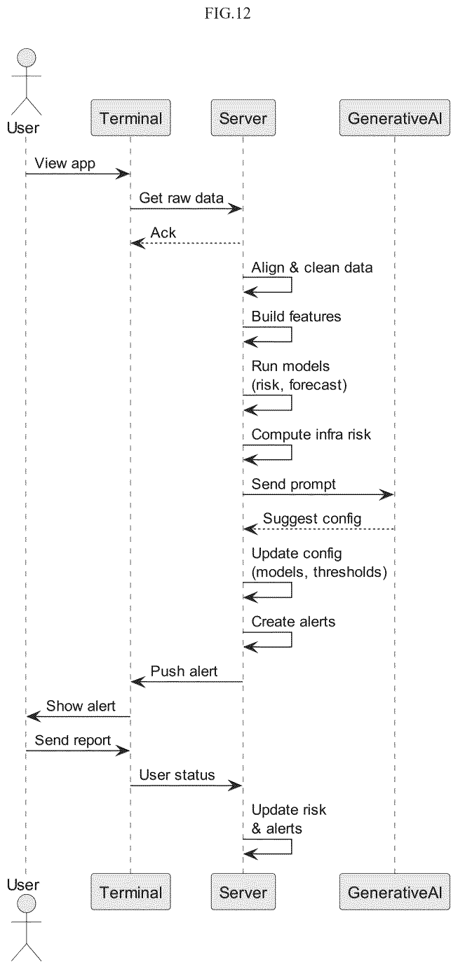

The following describes the processing flow using FIG. 12.

### Step 1:

Server acquires raw environmental information and observation information.

Server receives, as input, data streams and periodic data files from external information sources and observation devices, including weather data (for example, temperature, precipitation, wind, forecasts) and sensor data (for example, traffic flow, voltage, water level, packet loss).

Server parses the input into structured records containing at least a timestamp, a location identifier, a sensor or source identifier, a measurement type, and a measurement value.

Server validates data formats, discards malformed records, and writes valid records into a time-series database, thereby outputting normalized raw data entries indexed by temporal information and spatial information.

### Step 2:

Server performs temporal alignment and spatial association of the raw data.

Server takes, as input, the normalized raw data entries stored in the time-series database.

Server resamples the data to fixed time intervals by grouping measurements into time windows and computing aggregated statistics such as average, maximum, minimum, and sum.

Server associates each record with a spatial region, such as a grid cell, district, or infrastructure element, by mapping location identifiers or coordinates to region identifiers in a spatial database.

Server outputs integrated records in which each entry includes a region identifier, a time window, and aggregated measurement values from multiple sources.

### Step 3:

Server executes data quality control and preprocessing on the integrated records.

Server reads, as input, the temporally aligned and spatially associated records from Step 2.

Server identifies outliers by applying statistical rules (for example, range checks and z-score thresholds) and, optionally, model-based outlier detection such as an isolation forest.

Server removes or corrects outliers by replacing them with interpolated values or model-estimated values and detects missing intervals, filling short gaps by interpolation and flagging long gaps with low-quality indicators.

Server normalizes measurement scales and generates features such as moving averages, rate-of-change values, and cumulative sums, thereby outputting cleaned and feature-augmented records suitable for model input.

### Step 4:

Server constructs feature vectors for discrimination and prediction models.

Server takes, as input, the cleaned and feature-augmented records produced in Step 3.

Server groups measurements by region and time, and for each region-time pair, server compiles a feature vector including weather-related features, sensor-derived features, quality flags, and historical trend features.

Server arranges the feature vectors into model-specific data structures, such as matrices for tabular models or sequences for time-series models, and stores them in memory or in a model input table.

Server outputs the prepared feature vectors as the direct inputs for a discrimination model and a prediction model.

### Step 5:

Server evaluates disaster occurrence probabilities using a discrimination model.

Server receives, as input, the feature vectors from Step 4 designated for classification.

Server loads a pre-trained discrimination model, such as a gradient-boosted decision tree model, from persistent storage into memory.

Server applies the model to each feature vector to compute output values such as a probability that a specific type of natural disaster will occur in a given region within a forecast horizon.

Server outputs per-region probability scores and intermediate decision values, storing them as evaluation results in a risk evaluation table.

### Step 6:

Server predicts future quantitative states using a prediction model.

Server takes, as input, time-ordered feature sequences from Step 4 for each region.

Server loads a pre-trained time-series model, such as a recurrent neural network, a long short-term memory network, or a temporal convolutional network, from storage.

Server feeds each feature sequence into the prediction model to compute future trajectories of key variables, such as river levels, soil moisture indices, power outage probabilities, or traffic congestion indices.

Server outputs predicted time-series values and prediction uncertainty measures, and stores them in a prediction result table linked to the corresponding regions and time horizons.

### Step 7:

Server calculates influence degree, influence range, and risk indicators for infrastructure.

Server receives, as input, the evaluation results from Step 5 and the prediction results from Step 6.

Server combines disaster occurrence probabilities and predicted physical states with infrastructure vulnerability parameters such as elevation, historical failure rates, and redundancy metrics.

Server computes, for each infrastructure element (for example, road segment, power distribution area, water supply zone, communication cell), a numerical influence degree and an influence range that describe the severity and expected spatial-temporal extent of impact.

Server normalizes or categorizes these values to create risk indicators (for example, low, medium, high, or numeric scores between 0 and 1) and outputs a structured set of risk indicators per infrastructure element and per time window.

### Step 8:

Server generates a prompt sentence for a generative AI model based on current conditions.

Server takes, as input, the current risk indicators, evaluation results, model performance metrics, and configuration metadata.

Server assembles a textual description that includes data types (for example, traffic, power, water, communication), temporal resolution, spatial resolution, target natural disaster types, and observed performance issues.

Server formats this description into a prompt sentence, for example:

“Show a method for predicting the occurrence of traffic congestion under specific weather conditions using data from traffic sensors, rainfall sensors, and historical congestion records.”

or

“Design an algorithm that evaluates the risk of power outage with high accuracy based on time-series voltage, current, and frequency data from power sensors, combined with wind speed and precipitation forecasts.”

Server outputs the completed prompt sentence as a string prepared for transmission.

### Step 9:

Server transmits the prompt sentence to a generative AI model and receives response information.

Server uses, as input, the prompt sentence generated in Step 8.

Server sends the prompt sentence to a generative AI model via a network interface using an application programming interface and specifies context such as required output format and constraints.

Server receives response information from the generative AI model, including proposed feature extraction methods, model architectures, threshold-setting strategies, and evaluation criteria.

Server outputs a parsed representation of the response information, separating actionable configuration suggestions from descriptive text.

### Step 10:

Server updates internal configurations and processing logic based on the response information.

Server reads, as input, the parsed configuration suggestions from Step 9 and the current pipeline configuration stored in a configuration repository.

Server compares existing feature sets, model structures, and thresholds with the suggestions, and selects candidate modifications such as adding new cumulative features, adjusting the number of neural network layers, or changing alert thresholds.

Server writes updated configuration records into the configuration repository and, if necessary, triggers offline retraining or validation tasks to test new configurations.

Server outputs revised configurations that are used by subsequent executions of Steps 4 to 7, thereby adapting the processing pipeline to changing data conditions.

### Step 11:

Server generates alert information using risk indicators and updated alert criteria.

Server receives, as input, the risk indicators from Step 7 and the latest alert-generation rules and thresholds from Step 10.

Server determines, for each region and each infrastructure type, whether the risk indicators exceed the corresponding thresholds and, if so, classifies the alert type and severity (for example, advisory, warning, emergency).

Server composes alert information that includes the natural disaster type, estimated scale, expected occurrence time, estimated affected area, and recommended evacuation routes or detour routes calculated using a route computation algorithm on a road network graph.

Server outputs structured alert objects containing all necessary fields for distribution to terminals and public alert devices.

### Step 12:

Server distributes alert information to terminals and public alert devices.

Server takes, as input, the structured alert objects from Step 11.

Server sends push notifications to mobile terminals through a push notification service, including references to alert identifiers.

Server transmits detailed alert messages to public alert devices such as display boards and warning systems using dedicated communication channels.

Server outputs successfully delivered alert records and logs any transmission failures for retry or diagnostic processing.

### Step 13:

Terminal receives alerts and presents guidance to a user.

Terminal takes, as input, push notifications or direct messages sent by the server in Step 12.

Terminal invokes a mobile terminal application, requests full alert details from the server via a network request, and receives alert information including maps and route data.

Terminal renders the alert on a display, showing the affected area, recommended evacuation start times, evacuation routes, and routes to avoid, and provides interactive controls for the user to acknowledge or request more information.

Terminal outputs user-visible screens and, optionally, local log entries recording alert reception.

### Step 14:

User reviews alert information and provides response information.

User receives, as input, the displayed alert content on the terminal from Step 13.

User examines the described risks, routes, and timing and decides on an action such as starting evacuation or monitoring conditions.

User enters disaster-status report information or route passability information through the terminal application interface, for example by selecting options like “road X is flooded,” “route Y is blocked,” or by entering free-text comments.

User outputs this response as digitally encoded information to be transmitted back to the server.

### Step 15:

Terminal transmits user response information to the server.

Terminal takes, as input, the user-generated disaster-status report information and route passability information from Step 14.

Terminal packages this information into a structured message including user location, time of report, reported condition, and related alert identifier.

Terminal sends the message to the server via a secure network connection and receives an acknowledgment from the server.

Terminal outputs a confirmation to the user that the report has been sent and logs the transmission status.

### Step 16:

Server incorporates user response information into subsequent evaluations and influence calculations.

Server receives, as input, the response messages from terminals produced in Step 15.

Server associates each response with the relevant region, infrastructure element, and alert, and compares the user-reported conditions with sensor-based predictions and current risk indicators.

Server updates internal state by adjusting risk indicators, marking routes as impassable or verified safe, and, if necessary, recalculating influence degrees and influence ranges for affected regions.

Server outputs updated risk indicators and, when thresholds are crossed or conditions change significantly, generates revised alert information which may trigger new executions of Steps 11 through 13.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional natural disaster early-warning systems primarily focus on processing objective observation data, such as meteorological measurements and sensor readings, and broadcasting uniform alerts to broad populations. While such systems may compute occurrence probabilities of disasters, they generally do not account for heterogeneous user states, such as individual emotional conditions, cognitive load, or behavioral tendencies when receiving alerts. As a result, conventional alert-generation logic is typically implemented as a fixed rule engine or static template selection, which outputs generic messages that are not dynamically adapted to user context beyond coarse location-based targeting.

From a computer-technology standpoint, these conventional systems have multiple technical limitations. First, server-side alert generation pipelines lack a mechanism to systematically integrate multi-modal user-derived signals (for example, self-reported emotions, voice features, facial expressions, and interaction logs) as structured inputs into the core generation logic. The absence of such integration means that the server cannot compute and maintain, in a machine-usable representation, a “per-user emotional state” that can influence downstream processing stages such as risk mapping, template selection, or text generation. This restricts the system to relatively simple, broadcast-oriented control flows and prevents finer-grained, user-tailored behavior at the processor level.

Second, even where generative AI models are employed, conventional use patterns often treat such models as black-box text generators driven by ad hoc prompts crafted manually. There is no standardized processor-level mechanism for building prompt sentences from machine-derived risk indices and user states in a repeatable, constrained manner. Without a structured prompt-generation layer that is aware of both disaster-risk parameters and user-emotion parameters, the generative AI model may output text with inappropriate tone, excessive fear induction, or insufficient action guidance, thereby degrading the functional reliability of the overall computer system. Furthermore, the lack of formal evaluation and selection of generative outputs at the server side results in non-deterministic alert quality, which complicates system validation, regulatory compliance, and safety certification.

Third, conventional systems typically do not provide a closed-loop architecture in which user reactions to delivered alerts (for example, button selections, dwell time, follow-up requests) are fed back into a processor-controlled pipeline that updates internal models and modifies future prompt-generation behavior. Without such feedback-driven adaptation, the system cannot improve its effectiveness over time or dynamically adjust computational behavior across successive alert cycles. This leads to a static interaction model, in which the server's processing configuration is essentially fixed, despite the availability of rich runtime signals that could otherwise inform the configuration of generative models and notification logic.

Consequently, there is a need in the field of computer-based disaster-warning systems for an improved information processing architecture that: (i) acquires and fuses objective disaster-risk data with per-user emotional state information; (ii) programmatically constructs structured prompt sentences for a generative AI model, based on risk indices, geospatial segmentation, and emotional categories; (iii) evaluates and filters generative outputs according to machine-checkable constraints; and (iv) drives a feedback loop where user reactions are used to refine future prompts and notification strategies. Such a system would not merely change the content of alerts, but would improve the internal operation of the computer system itself, by defining new control flows, data structures, and model-integration mechanisms that enable robust, context-sensitive, and repeatable generation of warning messages at scale.

The specific processing by the specific processing unit 290 of the data processing device 12 in Example 2 is realized by the following means.

The present invention provides a server comprising a processor configured to acquire observation information related to natural phenomena from one or more observation devices; acquire user attribute information and location information from an information processing terminal; acquire, from the information processing terminal, information representing a user's emotional state that is estimated based on at least one of voice information, image information, operation information, and self-reported information; perform analysis processing on the observation information using at least one of a statistical technique, a mathematical model, and a machine learning model to calculate, for each type of natural disaster, an occurrence risk index and a danger level and to manage the occurrence risk index and the danger level for each region based on geospatial information; determine, based on the location information and the occurrence risk index and the danger level managed for each region, a natural disaster hazard area to which each user belongs and an occurrence risk index and a danger level corresponding to the natural disaster hazard area; generate, based on a predetermined template and by using as input information at least the information representing the user's emotional state and the determined natural disaster type, occurrence risk index, danger level, target region, and predicted occurrence time information, a prompt sentence to be input to a generative AI model, the prompt sentence including instruction conditions and constraint conditions that define a writing style, content range, and action-inducing properties of an output message; input the generated prompt sentence to the generative AI model, acquire a natural language text output from the generative AI model, evaluate the natural language text with respect to at least one of content length, presence or absence of prohibited expressions, and emotional tone, select a warning message candidate, and determine a final warning message; and generate notification data including the final warning message and additional information indicating at least the natural disaster type, the danger level, the target region, and a recommended action, transmit the notification data to the information processing terminal via a communication network, and cause the information processing terminal to present the final warning message by at least one of screen display and audio output. This enables an improved computer-implemented disaster-warning pipeline in which the processor dynamically fuses objective risk computations with individualized emotional state information, systematically constructs and constrains prompt sentences for a generative AI model, enforces machine-checkable quality and safety criteria on model outputs, and delivers user-tailored warning messages with controlled tone and content, thereby enhancing the reliability, adaptability, and technical performance of the overall information processing system.

The term “observation information” refers to digital data representing physical states or changes of natural phenomena, the data being obtained from one or more observation devices such as meteorological sensors, geophysical sensors, hydrological sensors, or other environmental measurement instruments.

The term “observation device” refers to a hardware apparatus configured to measure at least one physical quantity related to natural phenomena, such as temperature, precipitation, wind speed, ground acceleration, water level, soil moisture, or similar quantities, and to output corresponding digital observation information.

The term “user attribute information” refers to information indicating characteristics of a user, such as age group, residential area, presence of cohabiting persons, presence of persons requiring special care, or other demographic or contextual attributes relevant to disaster-warning processing.

The term “location information” refers to information indicating a geographic position of an information processing terminal or a user, including at least one of latitude, longitude, altitude, and a region identifier, which can be obtained from a positioning function of the terminal or a communication network.

The term “information processing terminal” refers to a computing device operated by a user, such as a mobile terminal, a portable information device, a tablet terminal, or an equivalent device, which includes at least a display, an input interface, a communication interface, and one or more sensors.

The term “user's emotional state” refers to information representing a psychological or affective condition of a user at a given time, expressed as at least one category label, such as calm, mild anxiety, high anxiety, or indifference, and optionally including a confidence score associated with the category label.

The term “voice information” refers to audio data representing speech or other vocal sounds of a user, the data being captured by a sound input function of an information processing terminal and being usable to extract acoustic features for emotion recognition.

The term “image information” refers to still image data or moving image data including at least a facial region of a user, the data being captured by an imaging function of an information processing terminal and being usable to extract facial-expression features for emotion recognition.

The term “operation information” refers to data indicating interaction behavior of a user with an application or a user interface, including at least one of tap operations, button selections, screen transition patterns, dwell time, and cancel operations.

The term “self-reported information” refers to information explicitly input by a user through a user interface element, such as a selection of a current feeling from a list of options or a direct input of an emotional condition.

The term “risk calculation unit” refers to a functional unit implemented by one or more processors and programs, the unit being configured to perform analysis processing on observation information using at least one of a statistical technique, a mathematical model, and a machine learning model, and to calculate, for each type of natural disaster, an occurrence risk index and a danger level.

The term “occurrence risk index” refers to a quantitative value indicating a likelihood that a specific type of natural disaster will occur within a predetermined time period and in a predetermined region, the value being expressed as a probability, score, or similar numerical measure.

The term “danger level” refers to a discretized classification of risk for a specific type of natural disaster, such as low, medium, or high, the classification being derived from the occurrence risk index according to predetermined thresholds or rules.

The term “geospatial information” refers to data describing positions, shapes, or extents of geographic objects, such as regions, hazard areas, and administrative boundaries, typically expressed by coordinates, polygons, or other spatial representations.

The term “natural disaster hazard area” refers to a geographic region determined by geospatial information and risk analysis, in which the occurrence risk index and danger level of at least one type of natural disaster satisfy a predetermined condition or exceed a predetermined threshold.

The term “determination unit” refers to a functional unit implemented by one or more processors and programs, the unit being configured to specify, based on location information and region-wise risk information, a natural disaster hazard area to which each user belongs and the occurrence risk index and danger level corresponding to the natural disaster hazard area.

The term “prompt generation unit” refers to a functional unit implemented by one or more processors and programs, the unit being configured to generate, based on at least one predetermined template, a prompt sentence to be input to a generative AI model by embedding into the template items such as a user's emotional state, natural disaster type, occurrence risk index, danger level, target region, and predicted occurrence time.

The term “prompt sentence” refers to a text sequence provided as input to a generative AI model, the text sequence including at least instruction conditions and constraint conditions defining a desired writing style, content range, tone, and action-inducing properties of an output message to be generated by the generative AI model.

The term “generative AI model” refers to an information processing model implemented by a machine learning framework, typically including a neural network such as a large-scale language model, which is configured to receive a prompt sentence as input and to generate a natural language text as output according to statistical patterns learned from training data.

The term “instruction conditions” refers to explicit directives included in a prompt sentence, which define how a generative AI model should behave, such as roles, objectives, number of message variants, target language, or level of detail of the output.

The term “constraint conditions” refers to limitations or rules included in a prompt sentence, which restrict the generative AI model's output with respect to factors such as prohibited expressions, target reading level, length constraints, tone constraints, or required use of bullet points.

The term “message generation unit” refers to a functional unit implemented by one or more processors and programs, the unit being configured to input a prompt sentence to a generative AI model, acquire a natural language text output from the generative AI model, evaluate the natural language text based on predetermined criteria, and determine a final warning message.

The term “natural language text” refers to a sequence of characters forming a sentence or sentences in a human language, generated by a generative AI model in response to a prompt sentence.

The term “warning message candidate” refers to a natural language text obtained from a generative AI model that is subject to evaluation and selection by the message generation unit before being determined as a final warning message.

The term “final warning message” refers to a warning message candidate selected by the message generation unit as satisfying predetermined quality, safety, and content criteria, which is to be delivered to an information processing terminal for presentation to a user.

The term “notification unit” refers to a functional unit implemented by one or more processors and programs, the unit being configured to generate notification data including at least a final warning message and associated metadata, and to transmit the notification data to an information processing terminal through a communication network.

The term “notification data” refers to data transmitted from a server to an information processing terminal, the data including at least a final warning message and additional information indicating at least one of a natural disaster type, a danger level, a target region, and a recommended action.

The term “recommended action” refers to information indicating one or more concrete behaviors that a user is advised to take in response to a predicted natural disaster, such as evacuating to a designated shelter, preparing emergency supplies, or confirming contact methods with family members.

The term “communication network” refers to a wired or wireless communication infrastructure, including at least one of the internet, a mobile communication network, and a local area network, through which data is exchanged between a server and one or more information processing terminals.

The term “screen display” refers to a presentation of information on a visual output device of an information processing terminal, such as a display or touch panel, in a form readable by a user.

The term “audio output” refers to a presentation of information as sound signals reproduced by an audio output device of an information processing terminal, such as a speaker or an earphone, and may include synthesized speech generated from text.

The term “lightweight emotion recognition model” refers to a machine learning model designed with a reduced computational complexity, memory footprint, or power consumption, which is suitable for deployment and inference on resource-constrained devices such as mobile terminals.

In the following embodiments, a server, a terminal, and a user cooperate to implement the claimed system. The same reference configuration can be deployed on one or more physical machines, virtual machines, or cloud instances. The embodiments are exemplary and do not limit the scope of the claims.

### 1. Overall Hardware and Software Configuration

Server executes the core processing of the disaster-warning system. Server is implemented on an information processing apparatus such as a rack-mounted server, a virtual machine in a data center, or a cloud computing instance. Server includes at least one central processing unit (CPU), a main memory, a non-volatile storage device, a network interface, and optionally a graphics processing unit (GPU) or accelerator for machine learning inference.

Server executes a server operating system such as a Linux-based operating system, and runs application software implemented using an application framework such as a web application framework. Server uses a relational database management system such as a general-purpose relational database, and optionally a spatial extension such as a geographic information extension. Server further uses software libraries for numerical computation and data processing, such as numerical-array libraries and data-frame libraries, and machine learning frameworks such as a general-purpose deep learning framework and a gradient-boosting library. Server accesses a generative AI model through an API running either as a cloud service or on-premises on a dedicated inference server.

Terminal is implemented as a mobile information processing apparatus, such as a smartphone, a portable information device, a tablet, or similar hardware. Terminal includes at least one processor, a memory, a display, a touch input interface, a microphone, a camera, a speaker, a positioning module (for example, a GPS receiver), and a network communication module supporting cellular and/or wireless local area communications. Terminal executes a mobile operating system and runs an application that implements the client-side functions of this system. User operates Terminal to register profile information, provide emotional-state inputs, and receive and react to warning messages generated by Server.

### 2. Acquisition and Preprocessing of Observation Information

Server acquires observation information related to natural phenomena from external observation devices such as meteorological sensors, hydrological sensors, geophysical sensors, and other environmental monitoring devices. Server uses network communication protocols such as HTTP, WebSocket, or a message-queue protocol to receive time-series data including, for example, precipitation intensity, river water level, ground acceleration, and slope inclination.

Server stores the raw observation information in staging tables in the relational database. Each record includes at least a sensor identifier, a timestamp, geospatial coordinates, and a measured value. Server uses data processing libraries to load batches of records into memory and performs preprocessing such as unit normalization, missing-value interpolation, and noise filtering. For example, Server applies a moving-average filter to a sliding window of recent measurements to suppress short-term spikes that are known to be sensor artifacts. Server also applies a statistical outlier detection algorithm, such as a z-score-based filter, to replace outlier values exceeding a predefined threshold with interpolated values.

Server converts the cleaned sequences into regularly-sampled time series aligned to a common time grid. Server stores these prepared time series in separate tables, including fields for a region identifier, time index, and feature vector components. This structured representation enables efficient batch input into machine learning models.

### 3. Risk Calculation by Machine Learning Models

Server executes risk calculation using machine learning models that are pre-trained using historical observation records and historical disaster occurrence labels. Server uses a deep learning framework to define and train an LSTM-based or transformer-based model for hydrological prediction. In one embodiment, the flood-risk model uses a multi-layer recurrent network with LSTM units, where each LSTM layer has, for example, 128 hidden units, and the model accepts as input a sequence of feature vectors containing precipitation and river-level measurements over a preceding time window (for example, 12 hours with 15-minute intervals).

Server trains this model offline using a training dataset labeled with future river levels after a fixed horizon (for example, 3 hours). Server uses a mean-squared-error loss as an objective function and applies backpropagation with an optimization algorithm such as Adam to update model weights. Server may apply data augmentation (for example, small random perturbations of input sequences and time stretching) to increase robustness to sensor noise.

Server also trains a landslide-risk model, for example, using a gradient-boosting decision tree algorithm. Input features may include averaged rainfall over multiple time scales, soil moisture, slope angle, and ground displacement derivatives. The target label is a binary or multi-class indicator of past landslide events. Server trains this model offline using a logistic loss or cross-entropy loss and tunes hyperparameters such as tree depth, learning rate, and number of estimators by cross-validation.

At runtime, Server loads the pre-trained models into memory. Server converts each region's prepared time series into model input tensors. For the flood-risk model, Server constructs a three-dimensional tensor [batch size, time steps, feature dimension], with standardized features. Server calls the model's inference function, which executes matrix multiplications and non-linear activation functions on CPU and/or GPU, and outputs predicted river levels over a future horizon. Server then computes an occurrence risk index as a probability that the predicted level exceeds a configured levee height. Server maps this probability into a discrete danger level, for example:
low if probability <0.3,
medium if 0.3≤probability<0.7,
high if probability ≥0.7.

For the landslide model, Server computes the probability of landslide occurrence for each slope segment based on the gradient-boosting model output and similarly discretizes the result into danger levels.

Server writes the occurrence risk indices and danger levels, together with associated region identifiers and time intervals, into a risk table. Because the models operate on structured tensors and use batched computation, Server reduces computational overhead compared to sequential rule-based computation and can compute risks for many regions simultaneously, improving throughput and latency under high-load conditions.

### 4. Management of Geospatial Risk Information and Hazard Areas

Server uses a spatial extension of the relational database to manage geospatial information such as administrative boundaries and hazard-zone polygons. Server associates each risk record with a polygon representing a geographic area, such as a grid cell or a river basin. Server computes this association offline by joining sensor locations with pre-defined geographic regions.

When Server updates risk records, Server stores for each region and disaster type the current occurrence risk index, the danger level, and validity time bounds. This allows Server to perform a simple key-based lookup rather than recalculating spatial relationships at alert time, thereby reducing runtime computation.

Server also defines “natural disaster hazard areas” as the polygons for which the danger level equals or exceeds a threshold (for example, medium or high). Server maintains an index on the geometry fields to accelerate point-in-polygon queries.

### 5. Acquisition and Estimation of User Emotional State at the Terminal

Terminal acquires user attribute information (for example, age group, presence of vulnerable persons) and location information via user input and positioning services, and transmits such information to Server as described previously. In addition, Terminal estimates the user's emotional state.

Terminal runs a client application that displays an emotion input interface. Terminal presents predefined labels such as “calm”, “a little anxious”, “very anxious”, and “near panic” on the display. User selects one label by touching the corresponding button. Terminal encodes this self-reported emotion as a one-hot vector or as an integer index.

Terminal also acquires voice information if User activates a voice-consultation function. Terminal collects an audio stream from the microphone via the audio API, segments the stream into frames (for example, 25 ms windows with 10 ms stride), and computes acoustic features including Mel-frequency cepstral coefficients, pitch contours, and energy. Terminal uses a lightweight deep neural network, implemented using a mobile inference library such as a mobile-oriented deep learning runtime, to infer an emotion distribution over categories like “anger”, “fear”, “sadness”, and “neutral” based on the acoustic features.

Terminal optionally acquires image information by capturing face images via the camera. Terminal applies a face-detection and facial-landmark extraction library to obtain the positions of key points such as eyes and mouth, and creates feature vectors representing eyebrow angle, mouth opening, and smile intensity. Terminal uses a compact convolutional neural network deployed as a mobile inference model to infer emotion categories such as “joy”, “surprise”, “fear”, and “disgust”.

Terminal further collects operation information by logging interaction sequences, including tap frequency, navigation patterns, and dwell time on specific screens. Terminal normalizes these logs into fixed-length time-windowed feature vectors (for example, counts and durations over the past few minutes).

Terminal concatenates the self-reported emotion encoding, acoustic emotion probabilities, facial emotion probabilities, and behavioral features into a single feature vector. Terminal normalizes each component based on pre-computed statistics to prevent any modality from dominating the others. Terminal passes the unified vector to a lightweight emotion recognition model stored in local memory. In one embodiment, this model is a feed-forward neural network with one or two hidden layers, each with, for example, 64 units, ReLU activations, and a softmax output over emotion categories “calm”, “mild anxiety”, “high anxiety”, and “indifferent”.

Terminal executes inference using the mobile model runtime, which performs matrix multiplications and activation evaluations. Terminal obtains a probability distribution over the four categories. Terminal selects the category with maximum probability as the user's emotional-state label and includes the maximum probability as a confidence score. Terminal then creates a structured data object containing the user identifier, timestamp, emotional-state label, and confidence score, and transmits this data via an encrypted channel to Server.

This local inference at Terminal reduces communication load because only compact labels and scores are transmitted, rather than raw audio or video streams. Furthermore, performing feature extraction and inference at the edge decreases latency and improves privacy, since sensitive raw data need not leave the device.

6. Mapping Users to Hazard Areas and Combining with Emotional State

Server receives emotional-state information and stores it in an emotion-history table, while also updating a current-emotion field in a user-state table. Server retrieves the latest location information for each user from a location table, identifies the region polygon that contains the user's coordinates using a spatial index, and then retrieves the corresponding risk records for each disaster type from the risk table.

Server creates a user-risk record that includes user identifier, disaster type, occurrence risk index, danger level, target region, and predicted occurrence time. Server associates this record with the user's current emotional-state label and confidence score. This combined representation serves as the basis for subsequent prompt generation.

By computing and storing these combined records, Server avoids recomputing spatial joins and risk retrieval at each message-generation invocation, thereby reducing processing overhead and enabling scalable handling of many users under time-critical conditions.

### 7. Prompt Generation for the Generative AI Model

Server generates a prompt sentence to be input into the generative AI model based on the combined user risk and emotional-state information. Server maintains a template repository containing text templates parameterized by placeholders. Each template corresponds to a specific combination of disaster type and emotional-state category. For instance, a “high-anxiety flood” template instructs the generative AI model to use a calming tone, avoid fear-inducing expressions, and include clear step-by-step actions.

Server selects a template based on the user's current emotional-state label and the highest-priority disaster risk (for example, the disaster type with the highest danger level). Server retrieves the selected template from storage and performs placeholder substitution using data from the user-risk record and user profile. Example placeholders include:
[EMOTION_STATE]
[CITY]
[DISTRICT]
[DISASTER_TYPE]
[RISK_LEVEL]
[EXPECTED_TIME]
[SHELTER_LIST]

Server fills in these placeholders with actual values. For example, when the emotional state is “high anxiety”, the disaster type is flood, the risk level is “high”, the predicted inundation onset time is “3 hours”, and the shelters are two specified facilities, Server generates the following prompt sentence:

“You are a disaster-prevention counselor. Based on the following conditions, generate two Japanese messages that calm the user while encouraging safe evacuation actions.

### Conditions:

User emotional state: high anxiety
User residential area: XX City, YY District
Target disaster: flood
Flood risk level: high
Expected inundation onset time: 3 hours from now
Recommended evacuation sites: nearby elementary school gymnasium (10 minutes on foot), local community center (15 minutes on foot)

### Constraints:

Avoid wording that induces excessive fear.
Present specific actions to take within the next three hours as a numbered list.
Use expressions understandable to junior high school students.”

Similarly, when the emotional state is “indifferent” and the disaster type is landslide with very high probability, Server may generate a prompt sentence such as:

“You are a disaster public relations officer. Based on the following conditions, generate two messages that strongly emphasize the necessity of evacuation to residents who tend to underestimate disaster risks.

### Conditions:

User emotional state: indifferent
Target disaster: landslide
Landslide occurrence probability: very high
Past disaster example: in a similar terrain, many houses were completely destroyed

### Constraints:

Persuade using facts and concrete past damage cases rather than threats.
At the end, present three bullet-point items describing ‘actions you can take immediately’.”

Server logs each generated prompt sentence along with user identifier, disaster type, and time to provide traceability and to support later analysis or model tuning.

By systematically constructing prompt sentences from structured risk and emotion data, Server ensures that the generative AI model is driven by precise, machine-controlled conditions rather than human-written ad hoc prompts. This structured prompting improves consistency, reduces the likelihood of inappropriate outputs, and provides a clear interface between symbolic system state and generative processing.

### 8. Generative AI Model Inference and Message Evaluation

Server sends the generated prompt sentence to a generative AI model. The generative AI model is implemented as a large-scale neural network, such as a transformer-based language model with multiple attention layers. This model is pre-trained on large corpora and optionally fine-tuned on domain-specific disaster communication text.

Server accesses the generative AI model via an API, passing the prompt sentence and generation parameters such as maximum output tokens, temperature, and top-k or top-p sampling parameters. The generative AI model executes attention-based computations on GPUs or specialized accelerators, computing token-by-token probabilities conditioned on the prompt sentence and previously generated tokens. The model outputs one or more candidate warning messages.

Server receives the candidate messages as natural-language texts. Server then performs automated evaluation using both rule-based and learned criteria. Rule-based filters scan the text for prohibited expressions, such as excessively alarming vocabulary or regulatory-prohibited terms. Learned criteria can be implemented by a secondary classifier that estimates, for each candidate text, a “calming score” and an “action-inducing score” based on features such as polarity, presence of directive verbs, and sentiment.

Server normalizes these scores and computes a combined utility score, for example:

combined_score=α×action_score+(1−α)×calming_score

where α is a tunable parameter. Server selects the candidate with the highest combined_score among those that pass the rule-based filters. Server designates the selected candidate as the final warning message. Because this evaluation step is performed systematically, Server can enforce consistent quality constraints across all messages generated by the generative AI model.

Server stores the final warning message and associated metadata (user identifier, disaster type, danger level, prompt identifier, and time) in a message table. This storage enables later auditing and, if necessary, retraining of evaluation modules.

### 9. Notification Generation and Presentation at the Terminal

Server generates notification data that includes the final warning message and additional information such as natural disaster type, danger level, target region, and recommended actions. Server also determines notification priority and channel (for example, push notification, in-app alert) based on the danger level and user context. For high-level risks, Server can specify high-priority notifications that trigger prominent visual and auditory alerts.

Server sends notification data through a push-notification service to Terminal. Terminal receives the notification via the mobile operating system's notification subsystem and displays a summary banner. When User taps the banner, Terminal opens the client application and requests detailed message contents from Server if only an identifier was included in the push payload.

Terminal presents the final warning message on the display, formatting it into sections such as “Disaster Type”, “Danger Level”, “Expected Time”, “Target Area”, and “Recommended Actions”. Terminal adjusts font size and contrast according to user accessibility settings. If User presses a “Read aloud” button, Terminal uses a text-to-speech API to convert the warning message text into audio. Terminal selects slower speech speed and a neutral voice for users with high-anxiety labels.

Terminal presents interactive buttons such as “Evacuate now”, “Show shelter on map”, “Learn more”, and “Remind me later”. When User selects “Show shelter on map”, Terminal launches a map application and passes the coordinates of the recommended shelter as parameters. When User selects “Learn more”, Terminal sends a reaction event to Server indicating that the user is requesting additional information.

### 10. Follow-Up Prompt Generation and Adaptive Behavior

Server receives user reaction events and attaches them to the user's history. When Server detects that User selected “Learn more” or spent a long time on the message screen, Server may generate a follow-up prompt sentence. This follow-up prompt specifically instructs the generative AI model to supplement the previous message without repeating main actions.

For example, Server may generate:

“You are a disaster-prevention counselor. The user has already received a basic flood warning message and is asking for more details. Based on the following conditions, generate a Japanese follow-up message that does not repeat the previous instructions, and instead provides more detailed guidance.

### Conditions:

User emotional state: high anxiety
Target disaster: flood
User residential area: XX City, YY District
Previous message content: [short summary or key points]

### Constraints:

Do not repeat the previous three main actions.
Add specific advice about items to bring, how to contact family members, and how to help elderly or disabled persons.
Use calm and reassuring tone.”

Server inputs this follow-up prompt into the generative AI model, evaluates the output as described above, and sends the resulting follow-up message to Terminal. This closed-loop mechanism enables Server to adapt the level of detail and content of future messages based on user behavior, improving system effectiveness over time.

### 11. Technical Effects and Improvement of Computer Technology

The described system produces several technical effects that go beyond mere automation of human tasks.

Server improves computational efficiency by structuring observation information and risk indices in region-based tables and by performing batched inference using optimized machine learning frameworks. This reduces processing time and enables real-time or near-real-time evaluation of disaster risks across a large number of regions.

Server reduces communication load and improves response latency by enabling Terminal to perform feature extraction and emotion-state estimation locally. Only compact labels and scores are transmitted from Terminal to Server, as opposed to high-volume raw audio or video data. This design choice lowers bandwidth consumption and permits timely updates of emotional state even under constrained network conditions.

Server improves accuracy and consistency of warning messages by encoding internal risk and emotion state into structured prompt sentences. The generative AI model is controlled not by ad hoc human-written prompts, but by machine-constructed texts that embed precise conditions and constraints. This architecture enhances the predictability of model outputs and facilitates automatic validation through machine-checkable criteria.

Server improves the internal functioning of the computer system by defining specialized modules (risk calculation unit, determination unit, prompt generation unit, message generation unit, and notification unit), each with specific data structures and interfaces. The modules communicate through normalized records (for example, user-risk records, prompt logs, message records), which allows straightforward scaling, caching, and fault isolation.

AI models in this system do not simply mimic human writing. The emotion recognition models and the generative AI model follow algorithmic rules and numerical optimization processes that are not directly applicable to human cognitive processes. For example, emotion recognition is performed through feed-forward propagation of feature vectors through multiple layers with learned weights and nonlinear activations. The generative AI model predicts the next token by computing attention-weighted combinations of previous tokens and hidden states, using numerical thresholds and softmax distributions. These operations are unique to machine computation and provide consistent, quantifiable behavior.

By integrating these models with structured prompt generation and post-generation evaluation, Server realizes a non-conventional control flow that includes: (i) multi-modal sensing and feature fusion at Terminal; (ii) risk-aware region mapping at Server; (iii) automated template selection and placeholder substitution; (iv) constrained generative text production; and (v) machine-based evaluation and selection of outputs before notification. This flow improves system-level metrics such as end-to-end latency, risk-communication accuracy, and robustness under high load. Multiple variants are possible within the scope of the claims. Server may employ other neural network architectures, such as transformer-based time-series models for risk prediction. Terminal may use an alternative emotion recognition model, such as a small convolutional network combined with temporal pooling. The generative AI model may be hosted entirely on-premises or as a cloud service. Prompt templates may be stored as structured configuration files or in a database. Different decision rules may be used for message selection, such as multi-objective optimization balancing information density and simplicity.

In all these embodiments, Server, Terminal, and User cooperate to implement a system wherein a generative AI model is driven by structured prompt sentences derived from objective risk indices and individualized emotional states, and wherein the computer system itself is improved through specialized data structures, algorithms, and control flows that enhance computational performance, accuracy, and reliability of disaster warning in the real world.

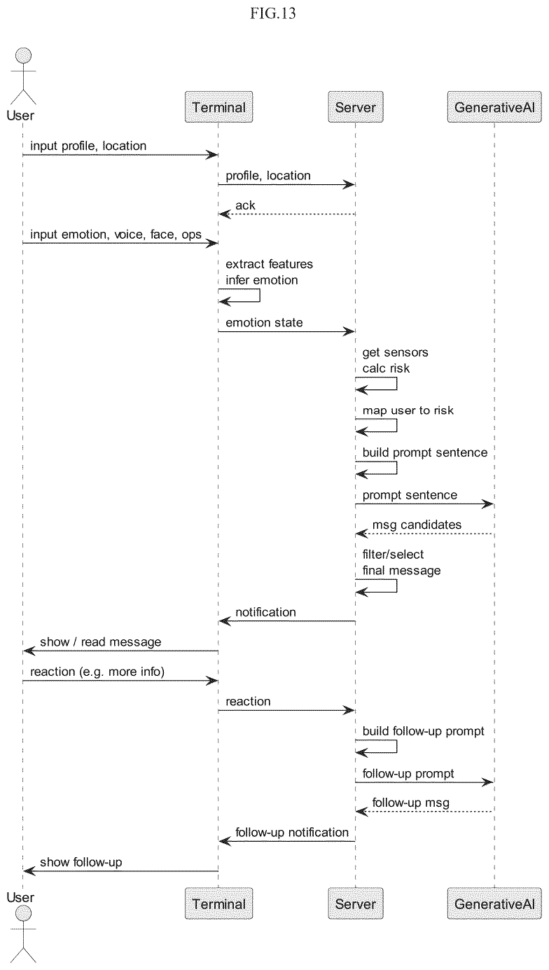

The following describes the processing flow using FIG. 13.

### Step 1:

Terminal acquires user profile and location and sends them to Server.

Terminal displays a registration screen and prompts User to input age group, residential area, presence of cohabiting persons, and presence of persons requiring special care. Terminal validates that all required fields are filled, and if a field is missing or out of range, Terminal shows an error message and prevents submission until correction. Terminal then calls a positioning API to obtain latitude and longitude.

Input: raw user keystrokes and selections, sensor-derived location data.

Processing: Terminal converts the user inputs into structured key-value pairs, converts the location into a standardized coordinate format, and packages both into a JSON object. Terminal may normalize text fields (for example, trimming spaces) and map area names to internal region identifiers.

Output: a profile-and-location payload transmitted via HTTPS from Terminal to Server, and a locally stored profile record on Terminal.

### Step 2:

Server receives user profile and location and stores them in structured tables.

Server accepts the HTTPS request from Terminal, parses the JSON body, and checks data types, mandatory keys, and value ranges. If the payload is valid, Server writes user attributes into a user profile table and the location into a user_location table, associating both with a user identifier. If invalid, Server returns an error response to Terminal.

Input: JSON payload containing user attribute information and location information.

Processing: Server performs schema validation, converts JSON into internal objects, normalizes text fields (for example, mapping area names to region codes), and creates SQL insert or update statements.

Output: persistent user profile and user_location records stored in the relational database, and an acknowledgment response to Terminal.

### Step 3:

Terminal acquires raw emotion-related data (self-report, audio, image, operations).

Terminal displays an emotion-selection interface with buttons such as “calm”, “a little anxious”, “very anxious”, and “near panic”. User taps one of the buttons to indicate current feeling.

Terminal records the selected label in memory. When User activates a voice-consultation feature, Terminal captures audio from the microphone, segments it into frames, and buffers it. When User consents to camera use, Terminal captures a facial image or short video frames. Terminal also logs UI interactions, including tap counts, dwell time, and navigation patterns.

Input: user button taps, microphone audio signal, camera image frames, and UI event logs.

Processing: Terminal encodes the self-reported label into a categorical value, stores audio frames as numeric arrays, stores image frames as pixel matrices, and aggregates raw operation events into time-stamped logs. No emotion inference is done yet in this step.

Output: stored raw emotion-related data structures (self-report label, audio buffer, image buffer, operation logs) in Terminal memory.

### Step 4:

Terminal extracts features and estimates the user's emotional state.

Terminal processes the buffered audio by computing acoustic features such as Mel-frequency cepstral coefficients, pitch contour, and frame energy. Terminal processes image frames by running a face-detection and landmark-extraction algorithm, and encodes facial expressions as quantitative features (for example, eyebrow raise angle, mouth openness ratio). Terminal transforms UI event logs into counts and durations over a time window. Terminal then concatenates these numerical feature vectors with an encoding of the self-reported label.

Terminal loads a lightweight emotion recognition model from local storage and runs inference to obtain probabilities for emotional categories (for example, calm, mild anxiety, high anxiety, indifferent).

Input: raw audio frames, facial image frames, operation logs, and self-reported emotion label.

Processing: Terminal performs digital signal processing (windowing, Fourier transforms, Mel filtering), computer-vision processing (face detection, landmark localization), behavioral feature aggregation (summations and averages), feature normalization, and neural-network forward propagation (matrix multiplications and activation functions).

Output: an emotional-state label (for example, “high anxiety”) and a corresponding confidence score, both time-stamped.

### Step 5:

Terminal sends the estimated emotional state to Server.

Terminal constructs an emotion_state payload that includes user identifier, emotional-state label, confidence score, and timestamp. Terminal opens an HTTPS connection and posts the payload to a designated endpoint on Server. If the network is unavailable, Terminal queues the payload and retries later.

Input: emotional-state label and confidence score generated by the emotion recognition model.

Processing: Terminal formats the emotion-state data into JSON, attaches authentication tokens, and handles network errors with retry logic.

Output: an emotion_state message transmitted to Server and optionally enqueued locally for retry.

### Step 6:

Server receives emotional-state information and updates user state.

Server's API endpoint parses the incoming emotion_state JSON, validates the category label and numeric range of the confidence score, and appends a record to an emotion_history table. Server also updates a current_emotion field in a user_state table so that the latest emotional state is quickly accessible.

Input: emotion_state JSON containing user identifier, label, confidence, and timestamp.

Processing: Server performs schema validation, converts JSON fields to database-compatible types, and executes insert and update SQL statements.

Output: updated emotion_history and user_state records in the database.

### Step 7:

Server ingests and preprocesses observation information from external devices.

Server periodically connects to external observation devices or data providers and collects raw observation information, such as rainfall, water level, ground acceleration, and slope displacement. Server stores the raw data in staging tables, then loads batches into memory to clean and normalize them.

Input: raw observation information streams from observation devices, including timestamps, sensor IDs, locations, and measured values.

Processing: Server applies unit conversion, noise filtering (for example, moving average or low-pass filters), missing-value interpolation, and outlier replacement using statistical thresholds.

Server aligns measurements to a fixed time grid and groups them by region or sensor.

Output: cleaned and time-aligned observation time-series records written into prepared data tables.

### Step 8:

Server calculates occurrence risk indices and danger levels by machine learning.

Server loads pre-trained machine learning models for each disaster type (for example, a recurrent network for floods, a gradient-boosting model for landslides) and feeds the prepared time-series data into them. Server computes predicted future values (for example, river level after several hours) and converts these predictions into occurrence risk indices (for example, probability of exceeding a danger threshold). Server then maps each index into a discrete danger level.

Input: cleaned time-series data grouped by region and disaster type.

Processing: Server builds input tensors or feature vectors, runs model inference (matrix multiplications, non-linear activations, decision-tree traversal), computes probabilities, and applies threshold-based classification to derive danger levels.

Output: risk records associating each region and disaster type with an occurrence risk index, a danger level, and a validity time window, stored in a risk table.

### Step 9:

Server maps each user to hazard areas and associates risk information.

Server retrieves each user's latest location from the user_location table and compares the coordinates against region polygons representing hazard areas. Server identifies which hazard regions contain the user's location and fetches the risk records for those regions. Server builds user_risk records linking user identifiers with disaster types, risk indices, danger levels, and predicted occurrence times.

Input: user location records and region-wise risk records with associated polygons.

Processing: Server executes spatial queries (point-in-polygon tests), performs database joins between location and risk tables, and constructs composite user_risk objects that combine location and risk attributes.

Output: user_risk records stored in a user_disaster_risk table, representing user-specific risk profiles.

### Step 10:

Server combines emotional state and risk information for each user.

Server accesses the current_emotion field for each user and retrieves corresponding user_risk records. Server then constructs combined context objects containing user identifier, emotional-state label, confidence score, disaster type, occurrence risk index, danger level, target region, and predicted occurrence time.

Input: user_state records (current emotion) and user_disaster_risk records.

Processing: Server performs keyed lookups and merges records based on user identifiers, assembling structured context objects for downstream processing.

Output: per-user risk-and-emotion context objects held in memory or cached in a context table.

### Step 11:

Server generates a prompt sentence for a generative AI model based on the context.

Server selects a prompt template that corresponds to the user's emotional state and the main disaster type. For example, Server chooses a “high anxiety” template for users labeled as high anxiety, and an “indifferent” template for users labeled as indifferent. Server then substitutes placeholders in the template with values from the context object, such as city name, district name, disaster type, risk level, predicted time, and recommended shelters. This produces a complete prompt sentence.

Input: combined risk-and-emotion context objects and prompt templates.

Processing: Server selects the appropriate template, substitutes placeholders with real values, concatenates static text segments with substituted segments, and performs basic text normalization (for example, ensuring consistent units and formatting).

Output: a fully composed prompt sentence text to be submitted to the generative AI model.

### Step 12:

Server submits the prompt sentence to the generative AI model and obtains candidate messages.

Server sends the prompt sentence to a generative AI model endpoint via an API call, including parameters such as maximum output length and sampling temperature. The generative AI model processes the prompt and returns one or more candidate warning messages as natural-language text. Server receives and parses the response.

Input: prompt sentence text and generation parameters.

Processing: Server formats an API request, transmits it, waits for the response, and extracts candidate messages from the returned payload.

Output: a list of warning message candidates in natural-language form.

### Step 13:

Server evaluates candidate messages and selects a final warning message.

Server examines each candidate message for length, presence of prohibited words or phrases, and compliance with tone constraints (for example, avoiding excessive fear language for high-anxiety users). Server may also run each candidate through an evaluation model that assigns scores for “calming” and “action-inducing” properties. Server combines these scores and selects the candidate that best satisfies configured criteria.

Input: set of candidate warning messages output by the generative AI model.

Processing: Server performs string analysis (length checks, keyword scanning), optional model inference for scoring, and ranking based on combined metrics or threshold rules.

Output: a single final warning message selected for the specific user, along with associated evaluation metadata.

### Step 14:

Server creates notification data and sends it to Terminal.

Server packages the final warning message and related metadata (disaster type, danger level, target region, recommended actions, and priority) into a notification object. Server then sends a concise version of this object, including at least an identifier and a short summary, to a push-notification service, which delivers it to Terminal.

Input: final warning message and message metadata.

Processing: Server constructs notification payloads, sets priority flags, calls push-notification APIs, and logs transmission results.

Output: notification data delivered to Terminal via a push service, and log entries recording the send operation.

### Step 15:

Terminal receives the notification and presents the warning to User.

Terminal's operating system receives the push notification and displays a banner or alert. When User taps the banner, Terminal launches the client application, retrieves the full warning message (if necessary) from Server using the included identifier, and renders a detailed warning screen.

Terminal shows the full text of the warning message and displays structured fields for disaster type, danger level, predicted time, target area, and recommended actions. If User activates a “Read aloud” function, Terminal uses a text-to-speech engine to output the message as spoken audio.

Input: notification payload from Server and, if needed, full message content retrieved via an API call.

Processing: Terminal parses the payload, resolves the message identifier to full content, formats the text for display, and optionally triggers text-to-speech synthesis.

Output: a visual and/or auditory warning presented to User on Terminal.

### Step 16:

Terminal captures User reactions and sends them back to Server.

Terminal displays interactive buttons such as “Evacuate now”, “Show shelter on map”, “Learn more”, and “Remind me later”. User selects one of these options or performs other interactions (such as scrolling or exiting). Terminal logs the selected action, the time taken to respond, and any subsequent navigation (for example, map view opened). Terminal then constructs a reaction payload and sends it to Server.

Input: user interactions with the warning screen, including button presses and navigation events.

Processing: Terminal converts raw UI events into structured reaction data (for example, action type, timestamp, and context), prepares JSON, and transmits it to Server.

Output: reaction data messages sent to Server and optionally stored locally for reliability.

### Step 17:

Server updates user behavior history and optionally generates follow-up prompts.

Server receives reaction data, writes it into a behavior history table, and analyzes it to determine whether follow-up information is needed. If, for example, User presses “Learn more”, Server creates a new context that includes a summary of the previous message and reaction type, selects an appropriate follow-up template, and generates a follow-up prompt sentence. Server then repeats the generative and evaluation process to produce a follow-up message, which is again packaged into notification data and sent to Terminal.

Input: reaction data from Terminal, previous warning message records, and prompt templates for follow-up content.

Processing: Server logs behavior data, evaluates triggers for follow-up generation, constructs a new prompt sentence incorporating reaction context, calls the generative AI model, evaluates new candidates, and prepares another notification.

Output: updated behavior history records and, when conditions are met, a follow-up warning or guidance message delivered to Terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional disaster warning systems typically apply fixed rule sets and template-based messages to all recipients, regardless of individual emotional states or heterogeneous information-consumption behaviors. These systems generally ingest meteorological information and sensor data, estimate natural disaster occurrence probabilities, and then broadcast uniform warnings through predetermined channels. As a result, such systems suffer from several technical limitations in how computing resources are used to generate, adapt, and deliver warnings.

First, existing architectures usually separate risk estimation from downstream communication logic, such that the same warning content and notification pattern are generated for all users assigned to a particular geographic region. The computing system therefore does not exploit fine-grained user-specific state information when deciding what message to generate, how to structure it, or over which routes and with what frequency to transmit it. This leads to sub-optimal use of processing, storage, and network resources, because repeated regeneration and retransmission of largely ineffective messages waste bandwidth and CPU cycles without improving user actions.

Second, typical systems lack integrated mechanisms to process multi-modal, user-side data (such as operation logs, voice inputs, and text inputs) as part of the core computational pipeline. Although user interfaces may collect inputs for feedback, conventional back-end architectures do not consistently extract behavioral, audio, and linguistic features or fuse them with objective risk data. Consequently, server-side processing pipelines cannot infer reliable user emotional states, cannot parameterize warning generation based on such states, and thus cannot computationally adapt message tone, structure, and urgency in a systematic and automated manner.

Third, while generative artificial intelligence models are increasingly used to produce natural language output, they are often invoked in an ad-hoc fashion, with static prompts and without a robust feedback loop tied to measurable user behavior. Conventional use fails to define a standardized server-side procedure for dynamically constructing prompt sentences from current risk and emotion context, validating generated text for content safety and structural constraints, and then learning from user reactions to update future prompts. This results in a computing pipeline in which the generative AI model behaves like an isolated component, without being optimized as part of the overall information-processing system.

Fourth, many known solutions do not implement feedback-driven optimization of the end-to-end system based on behavior induction rate. While user actions after notification (such as viewing evacuation information or following route guidance) can be logged, conventional systems rarely compute per-message behavior induction metrics in a manner that can be fed back into the generative pipeline. As a result, the system cannot systematically improve its generation and notification logic over time, leading to stagnant performance and inefficient utilization of server-side computation and communication resources.

Accordingly, there is a need for an improved computer-implemented disaster warning system that (i) unifies objective risk estimation and subjective emotional state estimation in a single processing pipeline, (ii) dynamically generates prompt sentences for a generative AI model based on combined risk-emotion context, (iii) automatically validates and optimizes generated warning messages for different user segments and delivery channels, and (iv) continuously adjusts its generation and notification behavior based on quantified user actions. Such a system should improve the technical functioning of the server by enabling more efficient computation paths, refined data flows, and adaptive use of communication channels, rather than relying on rigid templates and non-adaptive messaging logic.

The specific processing by the specific processing unit 290 of the data processing device 12 in Application Example 2 is realized by the following means.

The present invention provides a server comprising one or more processors and one or more memories storing instructions which, when executed by the one or more processors, cause the server to acquire observation information including meteorological information and infrastructure-related information, preprocess the observation information by performing time-series alignment, outlier removal, and missing-value completion, estimate a natural disaster risk based on the preprocessed observation information and disaster history information by using a statistical method or a machine learning method, acquire emotion-related information from user information processing devices including at least a part of operation history information, voice input information, and character input information, extract behavioral features, audio features, and linguistic features from the emotion-related information, estimate a comprehensive emotional state of each user by applying a plurality of emotion estimation models and integrating emotion state indices output by the plurality of emotion estimation models, generate a prompt sentence to be input to a generative AI model by dynamically embedding, into a predetermined sentence structure, condition information including a disaster type to be targeted, a target area, a predicted occurrence time, a recommended action, expression conditions, and an expression policy according to the comprehensive emotional state, input the prompt sentence to the generative AI model and obtain sentence data as an output from the generative AI model, perform content verification on the sentence data including prohibited-expression checking, structural-requirement checking, and length-constraint checking, generate an alarm message in which at least a disaster type, a target area, a recommended action, and an expression style are optimized for each user or user group, determine notification-path parameters and notification-frequency parameters, including types of electronic communication paths and re-notification intervals, based on the natural disaster risk and the comprehensive emotional state, transmit the alarm message to the user information processing devices or public notification devices according to the notification-path parameters and the notification-frequency parameters, acquire behavior history information from the user information processing devices after transmission of the alarm message, the behavior history information including at least viewing of evacuation information, activation of route guidance, and evacuation completion reporting, calculate a behavior induction rate for each alarm message based on the behavior history information, and update generation conditions of subsequent prompt sentences and alarm messages based on a correspondence relationship among the behavior induction rate, the prompt sentence, and expression features of the alarm message. This enables an integrated computer-implemented pipeline in which the server dynamically designs prompt sentences for a generative AI model from combined risk and emotion context, validates and optimizes generated messages for different user states and delivery channels, and continuously refines its processing and communication behavior based on measured user actions, thereby improving the efficiency, adaptability, and technical performance of the disaster warning system.

The term “observation information” refers to machine-readable data that represents physical, environmental, or operational conditions, including at least meteorological information and infrastructure-related information, together with associated time, location, and identification metadata.

The term “meteorological information” refers to information indicating atmospheric conditions in a region, including at least precipitation, temperature, humidity, wind, pressure, and related forecast or nowcast data, represented as digital data with temporal and spatial attributes.

The term “infrastructure-related information” refers to information indicating the operating state or load state of social or urban infrastructure, including at least transportation networks, power supply networks, water supply networks, communication networks, and related facilities, represented as digital data obtained from sensors, monitoring systems, or external data sources.

The term “time-series alignment” refers to a data processing operation in which observation information from multiple sources is ordered and adjusted along a common time axis, including at least sorting by timestamp and assigning records to fixed or logical time intervals.

The term “outlier removal” refers to a data processing operation in which values that fall outside of predetermined physical ranges or statistical thresholds are detected and excluded or marked as invalid in order to improve the reliability of subsequent analysis.

The term “missing-value completion” refers to a data processing operation in which missing or invalid data points in a time series are estimated and filled using a predetermined method, including at least interpolation methods, to form a temporally consistent dataset.

The term “natural disaster risk” refers to an index that represents the probability or expected severity of occurrence of a natural disaster event, such as a flood, landslide, strong wind, or similar phenomenon, within a specified region and time interval.

The term “disaster history information” refers to stored data describing past natural disaster events, including at least occurrence time, location, disaster type, magnitude, impact, and associated observation information, which is used as reference data for model training or comparison.

The term “statistical method” refers to an information-processing technique that estimates or infers relationships between variables based on statistical models, including at least regression analysis, probabilistic modeling, and time-series analysis.

The term “machine learning method” refers to an information-processing technique in which a model is trained on past data using a learning algorithm to predict or classify future or unknown data, including at least supervised learning, unsupervised learning, and reinforcement learning.

The term “user information processing device” refers to an end-user computing device capable of bidirectional communication with a server, including at least mobile terminals, tablet terminals, portable information devices, and personal computers.

The term “emotion-related information” refers to digital information obtainable from user interactions with a user information processing device, including at least operation history information, voice input information, and character input information, from which a user's emotional or psychological state can be inferred.

The term “operation history information” refers to log data representing interaction events performed by a user on a user information processing device, including at least taps, scrolls, button presses, screen transitions, text-input start events, text-input end events, and associated timestamps and identifiers.

The term “voice input information” refers to digital data representing an audio signal acquired from a microphone of a user information processing device, the data including at least speech content and acoustic characteristics of the user's voice.

The term “character input information” refers to digital text data representing character strings or sentences input by a user via a text-input interface of a user information processing device, including at least free-text queries, reports, or comments.

The term “behavioral features” refers to numerical or categorical descriptors computed from operation history information, including at least operation counts, screen transition counts, error rates, and text-input speeds within specified time windows.

The term “audio features” refers to numerical descriptors computed from voice input information, including at least spectral features, cepstral coefficients, pitch, energy, and speaking-rate indicators.

The term “linguistic features” refers to descriptors derived from character input information, including at least tokenized text, part-of-speech tags, sentiment indicators, and contextual embeddings derived from language models.

The term “emotion estimation model” refers to a learned or rule-based model that receives behavioral features, audio features, or linguistic features as input and outputs at least an index or score representing an emotional attribute such as anxiety, fear, or arousal.

The term “emotion state index” refers to a numerical or categorical value output by an emotion estimation model that represents the intensity or category of a user's emotional state along one or more dimensions.

The term “comprehensive emotional state” refers to a fused representation of a user's emotional condition obtained by combining a plurality of emotion state indices from multiple modalities, including at least a comprehensive anxiety score and an emotion category label.

The term “prompt sentence” refers to text data that is constructed according to a predetermined structure and input to a generative AI model in order to condition or specify the desired characteristics of the model's output.

The term “generative AI model” refers to a machine-learning model that, in response to input data including at least a prompt sentence, outputs newly generated content such as natural language text, and that is typically implemented as a neural network-based language model or multimodal model.

The term “condition information” refers to structured information used to generate a prompt sentence, including at least a disaster type to be targeted, a target area, a predicted occurrence time, a recommended action, expression conditions, and an expression policy according to a user's emotional state.

The term “expression conditions” refers to constraints or requirements on the style, tone, structure, or length of a message to be generated, including at least instructions to limit the number of bullet points, to use a calm tone, or to emphasize urgency.

The term “expression policy” refers to rules or guidelines that determine how information should be phrased or emphasized based on a user's emotional state, including at least policies for reducing panic, increasing risk awareness, or balancing reassurance and urgency.

The term “content verification” refers to a processing operation applied to generated sentence data to confirm compliance with predetermined constraints, including at least prohibited-expression checking, structural-requirement checking, and length-constraint checking.

The term “prohibited-expression checking” refers to a content-verification operation in which generated text is inspected to detect and reject or modify terms, phrases, or patterns that are not allowed according to legal, ethical, or policy rules.

The term “structural-requirement checking” refers to a content-verification operation in which generated text is inspected to confirm that required sections, formats, or item counts, such as the presence of bullet lists or specific headings, are satisfied.

The term “length-constraint checking” refers to a content-verification operation in which the number of characters, words, or tokens in generated text is evaluated to determine whether it falls within pre-specified minimum and maximum bounds.

The term “alarm message” refers to text information generated for the purpose of notifying a user about a natural disaster risk, the text including at least a disaster type, a target area, a predicted occurrence time, and recommended user actions.

The term “expression style” refers to a combination of linguistic attributes of an alarm message, including at least tone, formality, sentence structure, and the use of emphasis or bullet points.

The term “notification-path parameters” refers to control parameters specifying which communication channels or paths are to be used for delivering an alarm message, including at least push notifications, short text messages, electronic mail, and in-application displays.

The term “notification-frequency parameters” refers to control parameters specifying how often and at what intervals alarm messages are to be transmitted or retransmitted to a user, including at least initial send time, re-notification intervals, and maximum number of re-notifications.

The term “electronic communication path” refers to a means of electronically transmitting information from a server to a user information processing device or a public notification device, including at least network-based push services, messaging services, and email services.

The term “public notification device” refers to a communication or display device that provides information to a group of users in a shared environment, including at least public display panels, loudspeaker systems, and community alert terminals.

The term “behavior history information” refers to digital log data indicating actions taken by a user after reception of an alarm message, including at least viewing of evacuation information, activation of route guidance, and transmission of evacuation completion reports.

The term “behavior induction rate” refers to a quantitative index representing, for a given alarm message, a ratio or similar metric indicating how many users performed predetermined target actions relative to a set of users who received the alarm message within a defined time window.

The term “expression features of the alarm message” refers to descriptors that characterize the content and style of an alarm message, including at least features related to tone, structure, emphasis, and the ordering of information.

The term “generation conditions of prompt sentences” refers to configurable parameters and rules that determine how prompt sentences are constructed, including at least template selection, variable insertion rules, and expression conditions.

The term “generation conditions of alarm messages” refers to parameters and rules that influence the desired attributes of alarm messages generated by the generative AI model, including at least required sections, tone specifications, and length constraints.

In one embodiment, a server, a plurality of terminals, and users cooperate to implement the invention. The server comprises one or more general-purpose processors, a main memory, a non-volatile storage device, and a network interface, and executes an operating system and middleware for data processing and machine learning. The terminal comprises a processor, a display, input interfaces including a touch panel and a microphone, and a wireless communication interface, and executes a mobile operating system and an application program that interacts with the server. The user operates the terminal to receive alarm messages and to provide inputs such as voice and text.

The server uses hardware resources such as a multi-core central processing unit and, in some embodiments, one or more graphics processing units to perform computation-intensive machine-learning inference. The server executes a server-class operating system, a relational database management system, a distributed stream-processing framework, and machine-learning frameworks. For example, the server executes a Unix-like operating system, a relational database engine such as a relational database management system, a messaging middleware such as a distributed log service, and a data-processing engine such as a distributed in-memory computation framework. The server also executes a machine-learning framework such as a gradient-boosting library and a neural-network framework to implement the learning models described below.

The server acquires observation information from multiple external sensing devices deployed in an urban environment. The server receives, through the network interface and a message-queue system, machine-readable records including at least a sensor identifier, a timestamp, a geographic coordinate or region identifier, and one or more measured values. Exemplary sensing devices include traffic-flow meters, electrical-load meters, water-flow meters, communication-traffic counters, weather stations, river-level gauges, and ground-motion detectors. By using a message-queue system, the server can store incoming sensor data in a partitioned log and can process them in an ordered and fault-tolerant manner.

The server stores raw observation information in a structured format in the relational database. For each sensor, the server stores a time-ordered sequence of records, each of which includes fields such as “sensor_id,” “timestamp,” “location_id,” “measurement_type,” and “measurement_value.” In some embodiments, the server stores this information in a time-series oriented schema to enable efficient range queries by time and region. This specific data structure allows the server to perform vectorized and windowed operations during preprocessing, thereby improving processing throughput compared to naïve per-record handling.

The server executes a preprocessing module implemented on the distributed data-processing engine to perform time-series alignment, outlier removal, and missing-value completion in a batched and parallelized fashion. The server partitions the observation information by sensor identifier and region and sorts records within each partition by timestamp. The server aligns data to fixed time steps by constructing, for each sensor, a regular time grid and mapping each incoming record to the nearest grid point within a tolerance window. When a grid point has no corresponding record, the server creates a placeholder and marks it as missing. This alignment ensures that downstream models receive feature vectors with fixed dimensionality and consistent temporal spacing, which improves numerical stability and reduces the need for dynamic padding in model inference.

The server performs outlier removal by evaluating each measurement_value against a pre-configured physical range and a statistical range computed over a sliding time window. For example, the server computes, for each sensor type, a moving mean and standard deviation and marks a value as an outlier if its z-score exceeds a predetermined threshold. The server sets such values to missing and records an outlier flag, creating a clear separation between physically plausible and implausible readings. This reduces propagation of sensor faults into the learned models and thereby improves prediction accuracy.

The server performs missing-value completion by applying an interpolation method appropriate for the measurement type. In one embodiment, the server applies linear interpolation along the time axis using the nearest valid measurements before and after the missing point. In another embodiment, the server applies a more advanced interpolation such as spline interpolation or model-based imputation for variables with complex dynamics. The server writes the completed values into a cleansed observation table together with flags indicating which values were interpolated. Because the models receive complete vectors, runtime branching for missing data is reduced, leading to more efficient numerical computation and more predictable memory-access patterns.

The server estimates natural disaster risk by applying a learned model to features computed from the cleansed observation information. The server aggregates measurements per region and per time window into feature vectors including, for example, cumulative rainfall over multiple horizons, maximum and minimum river levels, short-term and long-term trends of water-level changes, power-consumption deviations from baseline, and communication-traffic anomalies.

The server normalizes each feature dimension using statistics computed from historical data and stores the normalized features in a model input buffer.

In one embodiment, the server uses a gradient-boosted decision-tree model trained to output a probability of occurrence for each disaster type (such as flood, landslide, or wind damage) within a prediction horizon. The server loads model parameters from persistent storage into memory and performs inference by traversing decision trees based on the values of the normalized features. In another embodiment, the server uses a neural-network model comprising multiple fully connected layers with nonlinear activation functions. The neural-network architecture may include, for example, an input layer with dimensionality equal to the number of features, two or more hidden layers with rectified linear unit activations, and an output layer with a sigmoid or softmax activation to produce probability values. The server performs matrix multiplications and activation evaluations using optimized numerical libraries and, optionally, graphics processing units for acceleration. The server then maps continuous probability outputs to discrete risk levels using configured thresholds, thereby producing a natural disaster risk index for each region. The terminal executes a dedicated application that logs user interaction events. The terminal attaches event listeners to graphical components such as buttons, scrolling regions, and text fields. When a user performs an action such as tapping a button, scrolling a list, or switching screens, the terminal records a log entry including at least a component identifier, a screen identifier, an event type, a timestamp, and additional context such as the number of characters entered. The terminal stores these log entries in a local queue and periodically transmits batched logs to the server via a secure communication protocol. This logging behavior introduces minimal latency to the user interface because logging is decoupled from immediate network transmission.

The terminal also acquires voice input information when the user chooses to report or query via speech. The terminal records audio from the microphone at a specified sampling rate and bit depth and stores the waveform in an audio file format. The terminal associates metadata such as the user identifier, start time, and recording duration and transmits the audio file to the server. Additionally, the terminal acquires character input information whenever the user submits a text message via a chat interface or form. The terminal attaches identifiers and timestamps and transmits this text data to the server as structured messages.

The server receives operation history information, voice input information, and character input information and stores them in separate tables. The server then executes feature-extraction modules. For behavioral features, the server groups log entries by user and time window and computes, for example, an operation count, a number of screen transitions, an error-event ratio, and an average typing speed. The server may compute derivatives such as acceleration of interaction frequency or sudden increases in error rates, which can serve as early indicators of confusion or stress.

For audio features, the server loads audio files and normalizes them to a uniform sampling format. The server divides each waveform into overlapping frames and applies a window function and a Fourier transform to each frame. The server then computes Mel-frequency cepstral coefficients, pitch contours, energy contours, and temporal statistics such as the proportion of voiced segments. These features are concatenated into fixed-length vectors. For linguistic features, the server tokenizes each user text into words or subword units, assigns part-of-speech tags, and identifies emotionally salient words using a lexicon or a sentiment classifier. In some embodiments, the server transforms the token sequence into a dense embedding vector by passing it through a pre-trained language encoder layer.

The server estimates a comprehensive emotional state by applying multiple emotion estimation models. For behavioral features, the server may use a classifier such as a gradient-boosted tree model to map feature vectors to discrete anxiety classes. For audio features, the server may use a convolutional neural network that processes spectrograms or a recurrent neural network that ingests sequences of acoustic vectors. For text features, the server may use a neural-network classifier that applies fully connected layers to embeddings produced by a language encoder. Each model outputs an emotion state index such as an anxiety score within [0,1] and optionally an emotion label.

The server integrates the emotion state indices across modalities by computing a weighted combination. For example, the server may assign greater weight to audio features when recent voice input is present and greater weight to text features when the user has provided rich textual content. The server normalizes the indices and applies a fusion rule such as a weighted average or a small neural network that takes the individual indices as input and outputs a comprehensive emotional state. The comprehensive emotional state includes at least a comprehensive anxiety score and an emotion category such as “normal,” “anxious,” or “near-panic.” By fusing multi-modal features at the server side, the invention improves robustness to noisy or missing data in any single modality and reduces the variance of emotional state estimates.

The server stores a situation context for each user by combining the natural disaster risk of the user's region with the user's comprehensive emotional state. The server determines the region for each user based on registration information or location data and queries the latest risk values for that region. The server then stores, in a context table, a record including at least the disaster type with the highest risk, the risk level, a predicted occurrence time window, a brief impact description, the comprehensive anxiety score, and the emotion category. This context table serves as a direct input to prompt generation, avoiding repeated joins and computations and thereby reducing processing latency when many users must be handled concurrently.

The server generates a prompt sentence for a generative AI model by selecting a template corresponding to the combination of risk level and emotional state and then embedding concrete values into the template. The server maintains multiple templates stored as parameterized strings with placeholders for fields such as disaster type, target area, predicted occurrence time, recommended actions, and expression policies. For example, when the comprehensive anxiety score is high and the user belongs to an elderly household in a high flood-risk area, the server can construct a prompt sentence as follows:

“You are a municipal officer in Japan and an expert at drafting messages that keep residents calm while still prompting them to act in emergencies.

Based on the following information, write an evacuation advisory message in Japanese for the target residents.

### [Resident Information]

Household type: Elderly household
Current psychological state: ‘Anxiety close to panic’
Comprehensive anxiety score: 0.85

### [Disaster Information]

Disaster type: Flood
Target area: XX City, YY District
Predicted occurrence time: 2-4 hours from now
Expected situation: The water level of a nearby river is rising rapidly, and some roads may become flooded

[Requirements]
Use a calm tone so as not to overstimulate anxiety.
First show, in up to three bullet points, ‘what should be done immediately’.
Then explain, in simple language, why these actions are necessary.
Limit the total length to 600 Japanese characters.”

When the comprehensive anxiety score is low despite a high risk, the server may construct a different prompt sentence:

“You are a disaster-risk communication specialist.

Based on the conditions below, create a Japanese message that strongly encourages action among residents who do not correctly understand the disaster risk.

### [Disaster Information]

Disaster type: Strong wind and landslide risk due to an approaching typhoon
Target area: XX City, ZZ District
Current risk level: High
Recommended action: Complete evacuation to the designated shelter by 20:00 tonight

### [Resident Emotional State]

Comprehensive anxiety score: 0.10 (normal level, lacking a sense of danger)

### [Requirements]

Clearly present the danger with concrete examples, and explicitly convey the risk of not evacuating.
Without causing excessive fear, include at the end a phrase that helps residents imagine the sense of relief once they have secured their safety.
Present three bullet points for ‘what may happen if they do not evacuate’ and three bullet points for ‘what can be prevented by evacuating’.”

The server may also generate a meta-prompt to improve templates over time:

“Below are three past evacuation advisory messages and the behavior-induction rate of each. Analyze the stylistic characteristics of each message and propose three new message templates that could further increase behavior-induction rates.

The target residents are those with a comprehensive anxiety score of 0.7 or higher, and it is important to balance easing anxiety with reliably inducing action.”

The server sends the generated prompt sentence to a generative AI model implemented as a large neural-network language model. In one embodiment, the generative AI model is a transformer-type network trained on a large corpus of text data. The model comprises an embedding layer that maps tokens to vectors, multiple self-attention layers that compute context-dependent representations, and an output layer that predicts the next token probability distribution. The server communicates with the generative AI model through an application-programming interface, transmitting the prompt sentence and generation parameters such as maximum output length and sampling temperature. The generative AI model returns generated text corresponding to a candidate alarm message.

The server verifies the generated text using a content-verification module. The server checks generated text against a list of prohibited expressions and patterns, evaluates whether required structural elements such as bullet lists and explanatory sections are present, and confirms that length constraints are satisfied. If the text fails any check, the server can either automatically adjust the text (for example, by removing or replacing certain phrases) or request a new generation with revised constraints. This explicit verification step introduces a deterministic control layer around the generative AI model, ensuring that the output conforms to the system's operational and safety requirements.

After validation, the server stores the alarm message and associated metadata and determines notification paths and frequencies. The server applies a rule-based or learned mapping that considers both the natural disaster risk and the comprehensive emotional state. For example, when the risk is high and the user is near panic, the server selects a high-priority path such as a push notification combined with an in-application popup and sets a short re-notification interval. When the risk is moderate and the user is calm, the server may choose a single push notification and an email with a longer interval. By computing notification-path parameters and notification-frequency parameters explicitly, the server can balance timely delivery with communication-network load, thereby reducing unnecessary traffic and improving overall system scalability.

The server transmits alarm messages over selected electronic communication paths. For push notifications, the server constructs a payload containing a brief summary and a message identifier and sends it via a push-notification gateway. For text messages or email, the server formats the content appropriately and sends it via corresponding gateways. The terminal receives notifications, displays summaries in the operating system's notification area, and, when the user taps a notification, opens the application and requests the full message from the server. The terminal then renders the alarm message, including headings, bullet lists, and visual emphasis such as color changes and icons. The user reads the message and may follow links to maps or shelter lists.

After message delivery, the terminal logs user actions related to the alarm message, such as opening the shelter list, invoking route guidance, or submitting an evacuation completion update, and sends behavior history information back to the server. The server associates these actions with particular alarm messages and computes a behavior induction rate by dividing the number of users taking target actions by the number of users who received the message within a defined period. The server stores these metrics and may use them as labels to update prompt-generation rules or to fine-tune models that predict message effectiveness.

From a technical standpoint, the described architecture improves computer functioning in multiple ways. By performing structured preprocessing and feature extraction, the server converts heterogeneous sensor and user-interaction data into fixed-format feature vectors that enable efficient batch processing in vectorized numerical libraries. This results in reduced computational overhead and improved throughput compared to unstructured or ad-hoc data handling. By fusing multi-modal emotion features and combining them with regional risk indices before prompt generation, the server reduces the search space of possible message types and enables more targeted use of the generative AI model. This leads to fewer redundant generations and less network communication with the model service.

Moreover, the explicit feedback loop that ties user behavior back to prompt sentences and alarm message characteristics is implemented as a concrete data flow: behavior induction rates are computed and stored as numeric metrics, and these metrics are used to adjust prompt templates, template-selection rules, and notification strategies. This feedback loop enables the server to automatically refine its internal decision policies in a way that is not achievable by manual, template-only systems. Because message generation, verification, notification, and feedback all occur in a closed computational loop, the system can converge to strategies that maximize action-inducing effectiveness while minimizing computational and communication costs.

The described generative AI model is not merely used to automate human drafting of text. The server embeds structured, machine-derived context into the prompt sentence and wraps the model's output in deterministic control logic, yielding a new type of computer-implemented pipeline. This pipeline exploits model internal behavior—such as token-level probability distributions, context-dependent attention representations, and parameterized decoding strategies—to produce outputs that are dynamically adapted based on objective risk and emotional state data. In some embodiments, the server adjusts generation parameters such as temperature or repetition penalties based on the user's emotional state to control variability and emphasis in the generated content.

Alternative embodiments may replace certain models or components without departing from the core technical concept. For example, the natural disaster risk model may be implemented as a recurrent neural network processing sequences of time-series features or as a graph-based neural network that models spatial relations between regions. The emotion estimation models may use different architectures, such as transformer-based encoders for text or attention-based models for audio, which may further improve accuracy in noisy environments. The generative AI model may be hosted on-premise or accessed via a remote service, and may support multiple languages or multimodal outputs such as combined text and icons. The notification-path selection may employ a reinforcement-learning agent that learns policies to balance timely delivery with load on communication infrastructure.

In all of these embodiments, the server, the terminal, and the user cooperate in a concrete, technically specified manner. The server performs specific data transformations and learning-based computations on defined data structures; the terminal performs event logging, local buffering, and user-interface rendering; and the user provides multi-modal inputs and receives actionable alarm messages. As a result, the invention provides an integrated, technically-grounded system that uses a generative AI model and prompt sentences not merely as a content-creation tool, but as part of an improved computer-implemented control loop for managing data processing, model inference, and message delivery in a resource-efficient, adaptive, and safety-constrained manner.

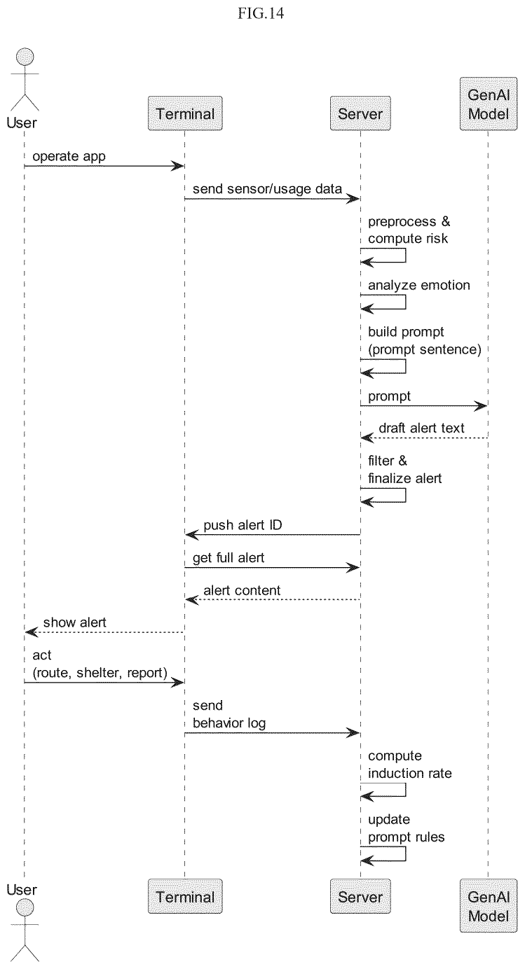

The following describes the processing flow using FIG. 14.

### Step 1:

Server acquires observation information.

Server receives, as input, a plurality of machine-readable sensor records from external sensing devices via a network interface and a message-queue system. Each input record includes at least a sensor identifier, a timestamp, a location identifier, and a measurement value. Server performs a data-format validation process, discarding malformed records and tagging valid records with an ingestion timestamp and a source identifier. Server writes the validated records into a raw observation table in a relational database as output, organizing them by sensor identifier and time for efficient subsequent processing.

### Step 2:

Server performs time-series alignment.

Server reads, as input, raw observation records for each sensor from the raw observation table. Based on this input, server sorts records by timestamp and constructs a regular time grid (for example, at one-minute or five-minute intervals) for each sensor. Server maps each record to the nearest grid point within a pre-defined tolerance, and when no record exists for a grid point, server creates an empty placeholder and marks it as missing. Server outputs an aligned time-series dataset in which each sensor has a fixed-interval sequence of values or missing markers, storing this dataset in an aligned observation table.

### Step 3:

Server performs outlier removal.

Server reads, as input, the aligned observation dataset from the aligned observation table. Server compares each measurement value to a configured physical range for the corresponding measurement type (for example, minimum and maximum plausible values) and computes a moving mean and standard deviation over a sliding time window to derive statistical thresholds. Based on this input, server identifies outlier values whose z-scores exceed a threshold or that fall outside physical ranges, sets such values to missing, and records an outlier flag for each modified entry. Server outputs a flagged observation dataset in which anomalous points are explicitly marked and excluded from direct use in modeling.

### Step 4:

Server performs missing-value completion.

Server receives, as input, the flagged observation dataset containing missing and outlier-replaced entries. For each time series, server identifies missing positions and selects a completion method such as linear interpolation between the nearest valid values before and after the gap. Server computes interpolated values by applying the chosen numerical method and fills the missing positions while maintaining original timestamps and identifiers. Server outputs a cleansed observation dataset with completed values and corresponding completion flags, and stores this dataset in a clean observation table for later feature construction.

### Step 5:

Server constructs regional feature vectors for risk estimation.

Server reads, as input, the cleansed observation dataset from the clean observation table. Server aggregates measurement values by region and by discrete prediction time windows (for example, every 10 or 30 minutes) and computes descriptive statistics such as recent cumulative rainfall, maximum wind speed, river-level gradients, and deviations from baseline loads in power or communication measurements. Server normalizes each aggregated feature using pre-computed mean and variance values. Based on this input, server forms fixed-length feature vectors for each region and time window and outputs these feature vectors into a model input buffer or a regional feature table.

### Step 6:

Server estimates natural disaster risk.

Server uses, as input, the regional feature vectors from the regional feature table. Server loads parameters of a pre-trained prediction model, such as a gradient-boosted decision tree model or a feed-forward neural network, from storage into memory. Server applies the model to each input feature vector, performing a series of arithmetic operations such as tree traversals or matrix multiplications and activation functions to compute probability values for one or more disaster types (for example, flood, landslide, wind damage) within a defined prediction horizon. Server converts these probability values into discrete risk levels (for example, low, medium, high) using configured thresholds and outputs a set of natural disaster risk records per region and disaster type into a region risk table.

### Step 7:

Terminal logs operation history information.

Terminal receives, as input, user interface interaction events generated by the operating system when the user taps, scrolls, presses a button, types text, or transitions between screens. For each input event, terminal captures associated attributes such as component identifier, screen identifier, event type, timestamp, and text length. Terminal performs a logging process that packs these attributes into a structured log record and enqueues the record in a local buffer. When the buffer reaches a count or time threshold, terminal transmits a batched operation history dataset to the server via a secure network protocol as output.

### Step 8:

Terminal records and sends voice input information.

Terminal detects, as input, a user action that activates a voice reporting or query function. In response to this input, terminal opens the microphone, configures sampling parameters (sampling rate, bit depth, channels), and starts capturing audio samples from the physical microphone device. Terminal accumulates raw audio samples in a memory buffer until the user stops recording or a maximum duration elapses. Terminal encodes the buffered samples into an audio file format and attaches metadata such as user identifier, start time, and recording duration.

Terminal outputs an audio input data packet containing the audio file and metadata and uploads this packet to the server over a secure connection.

### Step 9:

Terminal records and sends character input information.

Terminal receives, as input, text that the user enters into a text field and submits by pressing a send or submit control. Terminal captures the text string, user identifier, timestamp, and context identifier (for example, a screen or conversation identifier). Terminal performs a packaging process that structures this information into a character input record, optionally applying client-side redaction or length limits. Terminal outputs a character input dataset and transmits it to the server via a secure communication channel.

### Step 10:

Server extracts behavioral features from operation history information.

Server receives, as input, batched operation history datasets from multiple terminals and writes the records into a user event table. Server then groups events by user identifier and time window (for example, over the last 5 or 15 minutes) and computes, for each group, statistical measures including the total number of operations, number of screen transitions, number of error-related events, and average typing speed derived from text-input start and end events. Server further computes derived indicators such as sudden increases in interaction rate or error frequency. Based on this input, server outputs behavioral feature vectors per user and time window and stores them in a behavioral feature table.

### Step 11:

Server extracts audio features from voice input information.

Server receives, as input, audio input data packets containing audio files and metadata. Server reads each audio file from storage, converts it to a consistent internal format (for example, mono, fixed sampling rate, fixed bit depth), and divides the waveform into overlapping frames. Server applies a window function and computes a Fourier transform for each frame to obtain a magnitude spectrum. Server then derives numerical descriptors such as Mel-frequency cepstral coefficients, pitch values, energy values, and statistics representing speaking rate or voice stability. Server aggregates frame-level descriptors into recording-level feature vectors by computing means, variances, and other summary statistics. Server outputs audio feature vectors and stores them in an audio feature table linked to user identifiers and time windows.

### Step 12:

Server extracts linguistic features from character input information.

Server receives, as input, character input datasets containing user text and metadata. Server normalizes text by standardizing character forms and removing control characters, and then applies a tokenization and morphological analysis process to segment text into tokens and assign part-of-speech tags. Server identifies emotionally relevant words using a lexicon or a classifier and may convert token sequences into embedding vectors using a pre-trained language encoder. Based on these operations, server outputs linguistic feature representations for each text entry and stores them in a text feature table associated with user identifiers and message identifiers.

### Step 13:

Server estimates modality-specific emotional states.

Server uses, as input, behavioral feature vectors from the behavioral feature table, audio feature vectors from the audio feature table, and linguistic feature representations from the text feature table. Server applies a behavioral emotion estimation model to the behavioral features to compute a behavioral anxiety score or class. Server applies an audio emotion estimation model to the audio features to compute probabilities for emotion categories such as neutral, anxious, or fearful. Server applies a text emotion estimation model to the linguistic features to compute probabilities for emotions such as anxiety, anger, or sadness, and associated scores. The server executes these models using numerical operations such as tree evaluation or neural-network forward propagation. Server outputs multiple emotion state indices for each user and time window and writes them into an emotion index table.

### Step 14:

Server computes a comprehensive emotional state.

Server receives, as input, the modality-specific emotion state indices from the emotion index table. Server applies a fusion rule that assigns weights to each modality based on availability or reliability, and performs a weighted averaging or small neural-network computation to combine the indices into a single comprehensive anxiety score and a composite emotion category label.

Server may apply thresholds or decision boundaries in this fused feature space to categorize the user as “normal,” “anxious,” or “near-panic.” Server outputs a comprehensive emotional state record per user and stores these records in a user emotion state table.

### Step 15:

Server generates a situation context per user.

Server uses, as input, the natural disaster risk records from the region risk table and the comprehensive emotional state records from the user emotion state table. Server determines, for each user, the relevant region based on registration information or location logs and selects the risk record for that region. Server constructs, for each user, a situation context object that includes at least a dominant disaster type, risk level, predicted occurrence time window, short scenario description, comprehensive anxiety score, and emotion category. Server outputs these situation context objects into a user context table as structured records that will drive prompt generation.

### Step 16:

Server generates a prompt sentence for a generative AI model.

Server reads, as input, situation context records from the user context table. For each context, server selects a prompt template based on a combination of risk level and emotion category (for example, a “high risk, high anxiety” template or a “high risk, low anxiety” template). Server substitutes placeholders in the template with concrete values from the context, such as disaster type, target area, predicted occurrence time, recommended actions, and expression constraints.

Server concatenates static instruction text and embedded variable values to form a complete prompt sentence. Server outputs a set of prompt sentences, each associated with a user or user group and a generative task type.

### Step 17:

Server obtains generated alarm messages from a generative AI model.

Server uses, as input, the prompt sentences generated in Step 16. For each prompt sentence, server constructs a request object including the prompt sentence, model identifier, and generation parameters such as maximum token count and temperature. Server sends these requests to a generative AI model service via an application-programming interface and receives, as output, generated text sequences representing candidate alarm messages. Server parses the responses and stores the candidate messages in a generated message table along with the originating prompt identifiers.

### Step 18:

Server verifies and finalizes alarm messages.

Server reads, as input, candidate alarm messages from the generated message table. Server performs content verification by applying a series of checks: prohibited-expression checking against a pre-defined list of disallowed words and patterns, structural-requirement checking to ensure the presence of mandatory sections and bullet lists, and length-constraint checking to confirm that messages fall within allowed size limits. If a candidate message fails any check, server may mark it as invalid and optionally request regeneration with tighter constraints. Server outputs validated alarm messages as finalized records in an alarm message table, including metadata such as disaster type, target area, and target emotion category.

### Step 19:

Server determines notification paths and frequencies.

Server receives, as input, the validated alarm messages from the alarm message table and the latest natural disaster risk and comprehensive emotional state for each user. Server applies notification rules or policy models that map combinations of risk level and emotional state to specific notification-path parameters and notification-frequency parameters. For example, server may compute a notification profile specifying that a high-risk, near-panic user should receive push notifications with a short re-notification interval and in-application popups, whereas a medium-risk, normal user should receive a single push notification and an email. Server outputs a set of notification instructions that link each alarm message to users and channels, and stores these instructions in a notification schedule table.

### Step 20:

Server transmits alarm messages to terminals and public devices.

Server uses, as input, the notification instructions from the notification schedule table. For each instruction, server constructs a channel-specific payload, such as a push notification with a title, summary text, and message identifier, or a text message or email with a link to detailed content.

Server sends these payloads via appropriate communication gateways, including push notification services, messaging gateways, and email servers. Server records delivery attempts and results in a notification log as output.

### Step 21:

Terminal receives notifications and retrieves full alarm messages.

Terminal receives, as input, notification payloads from the operating system's notification framework. Terminal extracts a message identifier and summary text and displays a notification card or balloon to the user. When the user taps the notification, terminal launches the dedicated application and sends a request containing the message identifier to the server. Terminal receives, as output, the full alarm message content and associated metadata from the server and renders the content on the display, using formatting elements such as headings, bullet points, and icons to emphasize important instructions.

### Step 22:

User reads alarm messages and performs actions.

User receives, as input, the rendered alarm message on the terminal display. Based on the content, user may choose to tap user-interface controls to view a list of nearby shelters, open an evacuation route on a map application, or open a checklist for preparation steps. User may also input follow-up text or voice messages reporting status or questions. By performing these actions, user generates new operation, voice, and character inputs that the terminal records and forwards to the server.

### Step 23:

Terminal logs post-notification behavior and reports it to the server.

Terminal receives, as input, user actions executed after the alarm message is displayed, such as opening specific screens, launching a map, or marking a checklist item as completed. Terminal creates behavior event records that include at least an event type, timestamp, screen identifier, and associated message identifier. Terminal batches these behavior event records and transmits them to the server via a secure communication protocol as output, flagging them as post-notification behavior.

### Step 24:

Server computes behavior induction rates and updates generation conditions.

Server receives, as input, the post-notification behavior event records from terminals and associates each event with a corresponding alarm message using the message identifier and timestamps. Server counts, for each alarm message, the number of users who received the message and the number of users who performed pre-defined target actions (for example, opening evacuation routes or reporting evacuation completion) within a given time window. Server divides the number of acting users by the number of targeted users to compute a behavior induction rate for each alarm message. Server stores these rates and analyzes their correlation with prompt sentences and expression features of the alarm messages. Based on this analysis, server updates generation conditions such as template selection rules, weighting of expression policies, or notification strategies, outputting revised parameters that will affect future prompt generation and message delivery, thereby closing the feedback loop and continuously improving system performance.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

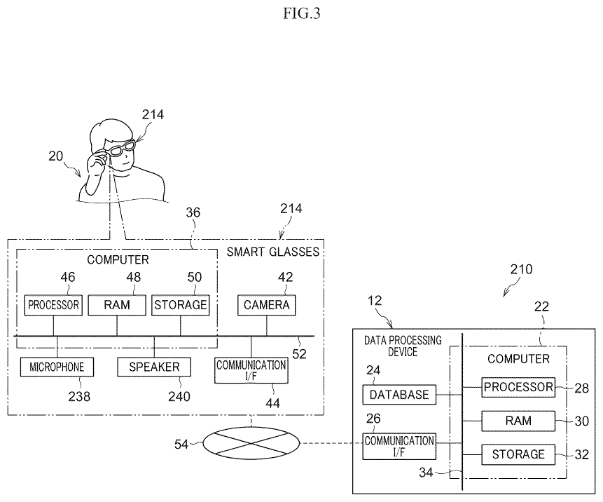

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

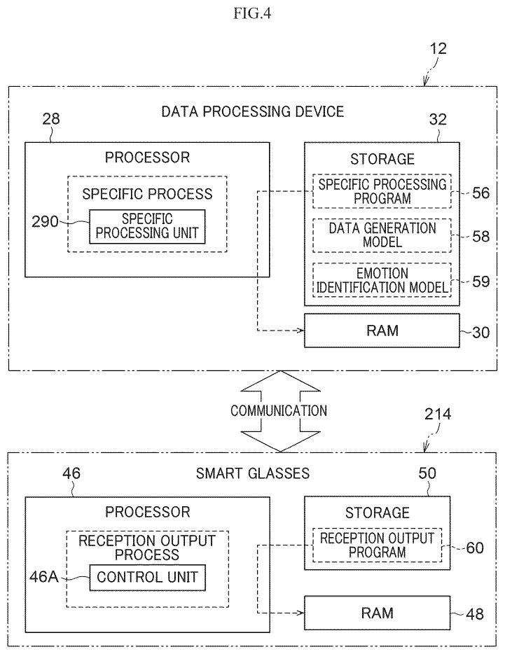

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

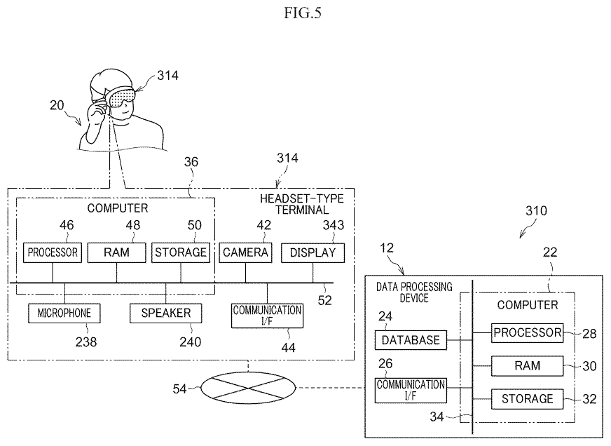

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

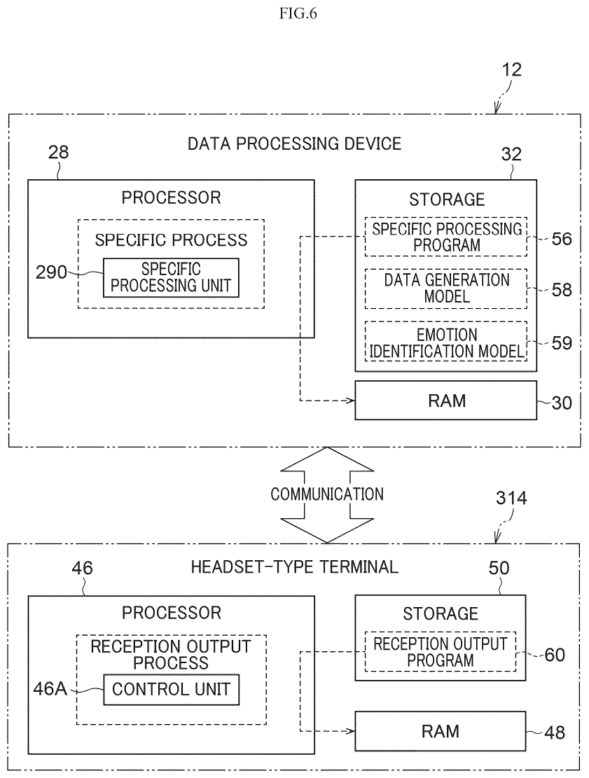

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

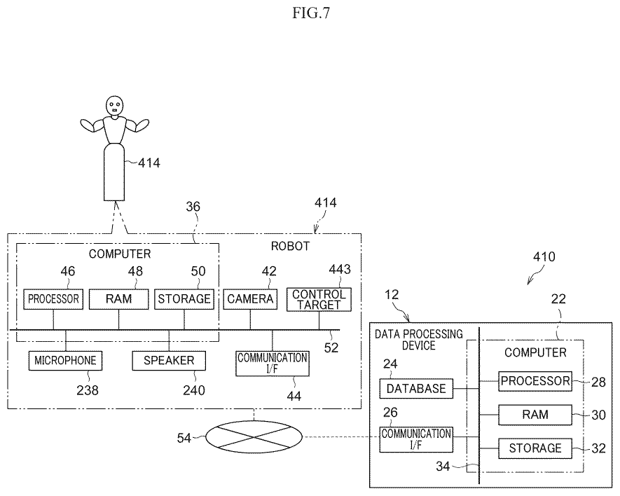

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

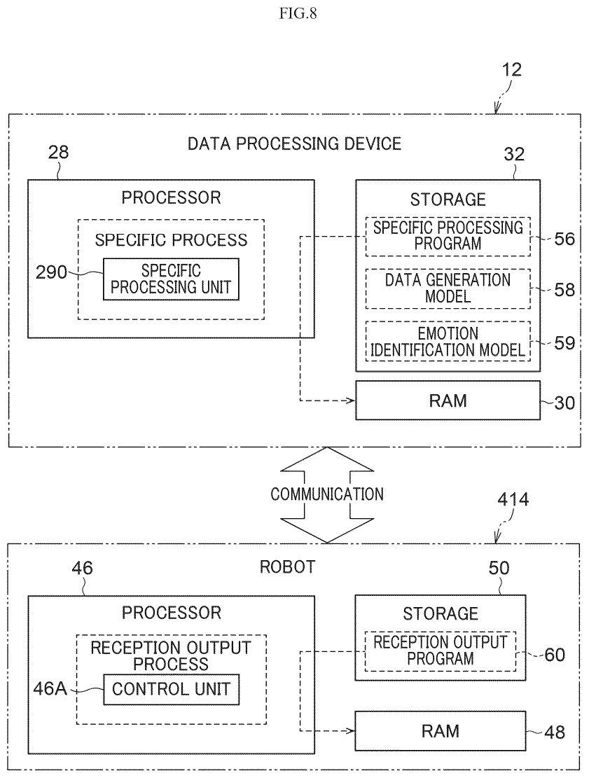

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

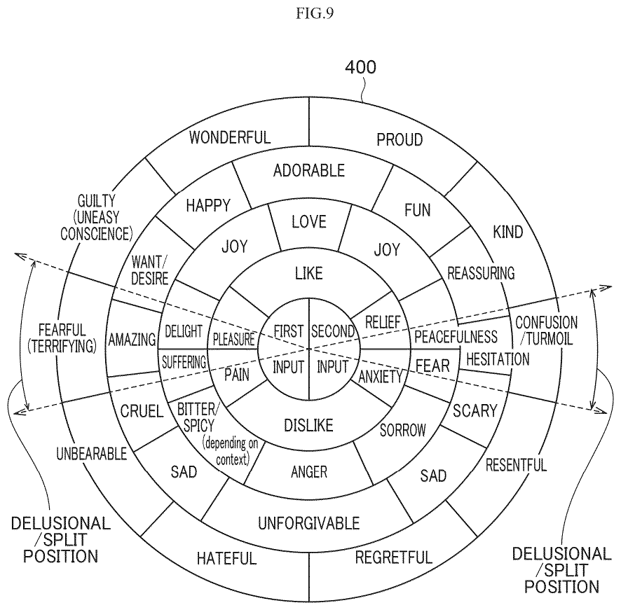

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

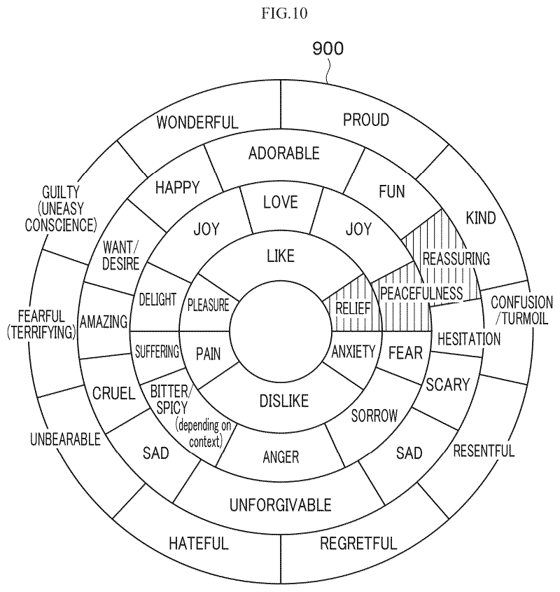

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, from one or more external information sources, environmental information relating to a plurality of types of natural phenomena, temporally and spatially align the environmental information based on time information and position information, and store the aligned environmental information as integrated data; and
receive observation information acquired from a plurality of types of measurement devices, perform abnormality detection, duplication detection, missing-value completion, and noise removal on the observation information based on physical constraints and logical constraints, and generate feature data by associating the observation information with the integrated data; and
calculate derived indicators relating to at least precipitation, water level, ground displacement, seismic waveform, and wind condition, based on the integrated data and the feature data, and generate, for each region and each time unit, an input data sequence; and
construct a training data set including labeled data indicating occurrence or non-occurrence of natural disasters and occurrence scale, by using the input data sequence and historical information relating to past natural disaster events, train a prediction model by a statistical learning method or a deep learning method, and register the trained prediction model and evaluation information thereof in a model management area; and
calculate, by using the trained prediction model, occurrence probabilities and risk indicators for each type of natural disaster with respect to the input data sequence updated at predetermined time intervals, and determine a danger level for each region; and
generate a prompt sentence describing analysis status, performance indicators, and improvement requirements regarding the trained prediction model and the danger level, the prompt sentence including information relating to the trained prediction model and the danger level, input the prompt sentence into a generative AI model, obtain proposal information from the generative AI model, the proposal information including at least one of a feature generation method, a model configuration, a threshold setting, and a warning text draft, and update at least one of the prediction model, a danger level determination process, and a warning text generation process based on the proposal information; and
generate warning data including, for each type of natural disaster, a warning level, a target region, a time margin, and recommended actions, based on the danger level, a predicted occurrence time, and a predicted influence range, and convert the warning data into a machine-readable format and a human-readable format; and
distribute the warning data to related organizations and residents via at least one of a short message communication means, an electronic document transmission means, a dedicated user terminal communication means, and a public warning distribution means, and record a distribution history and a delivery status; and
receive, from a user terminal, warning reception confirmation information and on-site situation report information, store the on-site situation report information in association with the integrated data and the danger level, and register the on-site situation report information as auxiliary labels usable for relearning of the trained prediction model or adjustment of a threshold;

### (Supplementary 2)

The system according to supplementary 1,
wherein the processor is configured to
generate the prompt sentence to be input into the generative AI model as content including at least a configuration of a plurality of types of environmental information, observation information, and historical information, misjudgment cases for each type of natural disaster, and target performance improvement goals, automatically generate, based on the proposal information obtained from the generative AI model, at least one of a change of a feature set configuration, a change of a model structure, a change of learning conditions, and a change of warning output conditions as an experimental condition, calculate evaluation indicators for each experimental condition to perform comparison, and adopt, in the model management area, only an update content that satisfies a predetermined criterion;

### (Supplementary 3)

The system according to supplementary 1,
wherein the processor is configured to
in generating the warning data, input into the generative AI model a prompt sentence including structured information regarding the danger level, occurrence probability, estimated damage scale, and time margin, obtain, from the generative AI model, a plurality of warning text candidates corresponding to user attributes and distribution media, perform a verification process on the warning text candidates based on predetermined safety criteria and expression rules, and, after selecting or modifying a warning text according to a result of the verification process, format the warning text into formats suitable for the short message communication means, the electronic document transmission means, the dedicated user terminal communication means, and the public warning distribution means, and distribute the formatted warning text.

### Application Example 1

### (Supplementary 1)

A system comprising a processor,
wherein the processor is configured to acquire environmental information and observation information as input data,
wherein the processor is configured to integrate the environmental information and the observation information based on temporal information and spatial information and perform preprocessing including outlier removal and missing-value completion on the integrated information,
wherein the processor is configured to apply a learned discrimination model or prediction model to the preprocessed information to extract feature values related to a natural event and to evaluate a probability of occurrence of a natural disaster,
wherein the processor is configured to calculate, based on a result of the evaluation, an influence degree and an influence range of the natural disaster on an infrastructure and to generate risk indicators for at least a road network, a power system, a water supply system, and a communication network,
wherein the processor is configured to generate and transmit a prompt sentence to a generative AI model by using the evaluation result and the risk indicators as input information, to receive response information relating to an analysis method, a prediction method, or a control policy from the generative AI model, and to automatically or semi-automatically update processing contents of the evaluation and influence calculation based on the response information,
wherein the processor is configured to generate alert information based on a result of the influence calculation, the alert information including at least a type, a scale, and an expected occurrence time of the natural disaster, an estimated affected area, and an evacuation route or a detour route, and
wherein the processor is configured to distribute the alert information to stakeholders and residents via a plurality of communication paths including an electronic communication path, a mobile terminal application, and a public alert device, and to store response information obtained from a mobile terminal of a user as additional input for subsequent evaluation and influence calculation.

### (Supplementary 2)

The system according to supplementary 1,
wherein the processor is configured to generate and transmit, to the generative AI model, the prompt sentence including a type of the observation information, a temporal resolution, a spatial resolution, and a target natural disaster type, to analyze proposal content output from the generative AI model regarding a feature extraction method, a model configuration, a threshold setting method, or an evaluation index, and to dynamically update a configuration of feature values used for the evaluation, threshold values used for the influence calculation, and conditions for alert generation.

### (Supplementary 3)

The system according to supplementary 1,
wherein the processor is configured to provide, to the mobile terminal application, action-guidance information including a recommended evacuation start time for each area, a recommended evacuation route, and a route to be avoided, based on the risk indicators for each infrastructure calculated by the influence calculation and an evacuation prioritization policy obtained from the generative AI model, and to acquire and incorporate, into an update of the risk indicators and the action-guidance information, disaster-status report information or route passability information transmitted from the mobile terminal.

### Example 2

### (Supplementary 1)

A system comprising a processor,
wherein the processor is configured to
acquire, by a first acquisition unit, observation information related to natural phenomena from one or more observation devices,
acquire, by a second acquisition unit, user attribute information and location information from an information processing terminal, and further acquire, from the information processing terminal, information concerning a user's emotional state that is estimated on the basis of at least one of voice information, image information, operation information, and self-reported information obtained at the information processing terminal,
perform, by a risk calculation unit, analysis processing on the observation information using at least one of a statistical technique, a mathematical model, and a machine learning model to calculate, for each type of natural disaster, an occurrence risk index and a danger level, and manage the occurrence risk index and the danger level for each region on the basis of geospatial information,
perform, by a determination unit, processing for specifying, on the basis of the location information and the occurrence risk index and the danger level managed for each region, a natural disaster hazard area to which each user belongs and an occurrence risk index and a danger level corresponding to the natural disaster hazard area,
generate, by a prompt generation unit, a prompt sentence to be input to a generative AI model, the prompt sentence being generated, on the basis of a predetermined template, by using as input information the information concerning the user's emotional state and at least one of a type of natural disaster, an occurrence risk index, a danger level, a target region, and time information of a predicted occurrence specified by the determination unit,
input, by a message generation unit, the prompt sentence generated by the prompt generation unit to the generative AI model, acquire a natural language text output from the generative AI model, evaluate the natural language text with respect to at least one of content length, presence or absence of prohibited expressions, and emotional tone, select a warning message candidate, and determine a final warning message, and
generate, by a notification unit, notification data including the warning message and additional information indicating at least one of a type of natural disaster, a danger level, a target region, and a recommended action associated with the warning message, transmit the notification data to the information processing terminal via a communication network, and cause the information processing terminal to present the warning message by at least one of screen display and audio output.

### (Supplementary 2)

The system according to supplementary 1,
wherein the processor is configured to
cause the second acquisition unit to, at the information processing terminal, acquire a self-reported emotion input by the user, an audio signal obtained by a voice input function, a facial image obtained by an imaging function, and an application operation history, extract features from the acquired information, input the features to a lightweight emotion recognition model disposed in the information processing terminal, calculate a category label and a confidence score representing the user's emotional state, and transmit the category label and the confidence score to the system as the information concerning the user's emotional state.

### (Supplementary 3)

The system according to supplementary 1,
wherein the processor is configured to
cause the prompt generation unit to select, in accordance with the user's emotional state, at least one template among a template for a user with a high anxiety level, a template for a user in a calm or mildly anxious state, and a template for a user who underestimates a disaster risk, and to generate the prompt sentence by embedding, into placeholders of the selected template, at least one of a type of natural disaster, a target region, an occurrence risk index, a danger level, time information of a predicted occurrence, and information related to a recommended action, such that the prompt sentence includes instruction conditions and constraint conditions for controlling a writing style, content, and action-inducing properties of the warning message generated by the generative AI model.

### Application Example 2

### (Supplementary 1)

A system comprising a processor,
wherein the processor is configured to
acquire observation information including information related to meteorology and information related to social infrastructure, by using an information acquisition unit,
perform preprocessing on the observation information, the preprocessing including time-series alignment, outlier removal, and missing-value completion, and estimate a natural disaster risk by using an analysis unit that applies a statistical method or a machine learning method based on the preprocessed observation information and past disaster history information,
acquire emotion-related information from a user information processing device, the emotion-related information including at least a part of operation history information, voice input information, and character input information, extract behavioral features, audio features, and linguistic features from the emotion-related information, and estimate a comprehensive emotional state of a user by using an emotion analysis unit that calculates emotion state indices by a plurality of emotion estimation models and integrates the emotion state indices,
generate, by using a prompt generation unit, a prompt sentence to be input to a generative AI model, the prompt sentence being dynamically generated by embedding, into a predetermined sentence structure, condition information including a disaster type to be targeted, a target area, a predicted occurrence time, a recommended action, expression conditions, and an expression policy according to the emotional state based on the natural disaster risk and the comprehensive emotional state,
input the prompt sentence generated by the prompt generation unit to the generative AI model, perform content verification including prohibited-expression checking, structural-requirement checking, and length-constraint checking on sentence data obtained as an output result from the generative AI model, and generate, by using an alarm generation unit, an alarm message in which at least a disaster type, a target area, a recommended action, and an expression style are optimized for each user or user group,
determine, based on the natural disaster risk and the comprehensive emotional state, notification-path parameters and notification-frequency parameters including types of electronic communication paths and re-notification intervals, and transmit, by using a notification unit, the alarm message to the user information processing device or a public notification device according to the parameters, and
calculate, after transmission of the alarm message, a behavior induction rate for each alarm message based on behavior history information including viewing of evacuation information, activation of route guidance, and evacuation completion reporting, the behavior history information being acquired from the user information processing device, and update, by using a feedback learning unit, generation conditions of subsequent prompt sentences and alarm messages based on a correspondence relationship among the behavior induction rate, the prompt sentence, and expression features of the alarm message.

### (Supplementary 2)

The system according to Supplementary 1,
wherein the processor is configured to output the natural disaster risk as a probability value and a risk level by causing the analysis unit to compare the past disaster history information with current observation information and perform a pattern recognition process by using a learned model constructed with a machine learning algorithm.

### (Supplementary 3)

The system according to Supplementary 1,
wherein the processor is configured to cause the notification unit to use at least a part of electronic mail, short text message, notification by a dedicated application, and notification by a public alarm device to promptly notify the alarm message obtained from the generative AI model, the alarm message including at least a type of natural disaster, a scale, an area having a high probability of occurrence, a predicted occurrence time, and a recommended action according to the emotional state of the user.

What is claimed is:

1. A system comprising:
circuitry configured to:
acquire, via a communication interface coupled to a packet-switched network, meteorological information as weather information from at least one external source;
acquire sensor data from at least one sensor;
analyze the weather information and the sensor data to generate an analysis result;
predict an occurrence of a natural disaster based on the analysis result;
generate an alert relating to the predicted natural disaster; and
notify the alert to related organizations and residents via the communication interface.

2. The system according to claim 1, wherein the circuitry is further configured to:
compare past natural-disaster data with current weather information and current sensor data, and recognize patterns using a machine learning algorithm, so as to predict the occurrence of the natural disaster.

3. The system according to claim 2, wherein the circuitry is further configured to:
perform preprocessing on the weather information and the sensor data, the preprocessing including time-series alignment based on temporal information, outlier removal, and missing-value completion, and
apply a learned prediction model to the preprocessed weather information and the preprocessed sensor data to extract feature values related to the natural disaster and to evaluate a probability of the occurrence of the natural disaster.

4. The system according to claim 3, wherein the circuitry is further configured to:
calculate, based on a result of the evaluation, an influence degree and an influence range of the natural disaster on an infrastructure, and
generate risk indicators for at least a road network, a power system, a water supply system, and a communication network.

5. The system according to claim 4, wherein the circuitry is further configured to:
generate alert information based on the risk indicators, the alert information including at least a type of the natural disaster, a scale of the natural disaster, an expected occurrence time, an estimated affected area, and an evacuation route or a detour route, and
distribute the alert information to the related organizations and residents via a plurality of communication paths including an electronic communication path, a mobile terminal application, and a public alert device.

6. The system according to claim 5, wherein the circuitry is further configured to:
acquire, from a mobile terminal of a user, disaster-status report information or route passability information, and
update the risk indicators and the alert information based on the disaster-status report information or the route passability information.

7. The system according to claim 1, wherein the circuitry is further configured to:
generate a prompt sentence to be input to a generative AI model, and
transmit the prompt sentence to the generative AI model via the communication interface.

8. The system according to claim 7, wherein the circuitry is further configured to:
receive, from the generative AI model, response information relating to at least one of a feature extraction method, a model configuration, a threshold setting method, and an evaluation index, and
update processing contents of the analysis result based on the response information.

9. The system according to claim 8, wherein the circuitry is further configured to:
input the prompt sentence to the generative AI model, the prompt sentence including structured information regarding a danger level, an occurrence probability, an estimated damage scale, and a time margin,
obtain, from the generative AI model, a plurality of warning text candidates corresponding to user attributes and distribution media,
perform a verification process on the warning text candidates based on predetermined safety criteria and expression rules, and
select or modify a warning text according to a result of the verification process.

10. The system according to claim 1, wherein the circuitry is further configured to:
acquire, from an information processing terminal, information concerning an emotional state of a user, the information concerning the emotional state being estimated on a basis of at least one of voice information, image information, operation information, and self-reported information obtained at the information processing terminal.

11. The system according to claim 10, wherein the circuitry is further configured to:
at the information processing terminal, acquire a self-reported emotion input by the user, an audio signal obtained by a voice input function, a facial image obtained by an imaging function, and an application operation history,
extract features from acquired information,
input the features to a lightweight emotion recognition model disposed in the information processing terminal, and
calculate a category label and a confidence score representing the emotional state of the user.

12. The system according to claim 11, wherein the circuitry is further configured to:
select, in accordance with the emotional state of the user, at least one template among a template for a user with a high anxiety level, a template for a user in a calm state, and a template for a user who underestimates a disaster risk, and
generate a prompt sentence by embedding, into placeholders of the selected template, at least one of a type of the natural disaster, a target region, an occurrence risk index, a danger level, time information of a predicted occurrence, and information related to a recommended action.

13. The system according to claim 1, wherein the circuitry is further configured to:
notify the alert using at least one of electronic mail, a short text message, a dedicated application, and a public alert system, the alert including at least a type of the predicted natural disaster, a scale of the predicted natural disaster, a region having a high probability of the occurrence of the predicted natural disaster, and a predicted occurrence time of the predicted natural disaster.

14. The system according to claim 13, wherein the circuitry is further configured to:
provide, to a mobile terminal application, action-guidance information including a recommended evacuation start time for each area, a recommended evacuation route, and a route to be avoided, based on risk indicators for each infrastructure.

15. The system according to claim 14, wherein the circuitry is further configured to:
acquire, from the mobile terminal application, behavior history information including viewing of evacuation information, activation of route guidance, and evacuation completion reporting, and calculate a behavior induction rate for each alert based on the behavior history information.

16. The system according to claim 15, wherein the circuitry is further configured to:
update generation conditions of subsequent prompt sentences and alert messages based on a correspondence relationship among the behavior induction rate, a prompt sentence used to generate the alert, and expression features of the alert.

17. The system according to claim 1, wherein the circuitry is further configured to:
integrate the weather information and the sensor data based on temporal information and spatial information, and
calculate, for each type of natural disaster, an occurrence risk index and a danger level, and manage the occurrence risk index and the danger level for each region on a basis of geospatial information.

18. A system comprising:
circuitry configured to:
acquire, via a communication interface coupled to a packet-switched network, meteorological information as weather information from a plurality of external sources;
acquire, via the communication interface, sensor data from a plurality of sensors;
perform preprocessing on the weather information and the sensor data, the preprocessing including time-series alignment, outlier removal, and missing-value completion;
apply a learned prediction model to the preprocessed weather information and the preprocessed sensor data to extract feature values and to calculate, for each type of natural disaster, an occurrence risk index and a danger level for each region on a basis of geospatial information;
generate a prompt sentence including structured information regarding the danger level, the occurrence risk index, an estimated damage scale, and a time margin;
transmit the prompt sentence to a generative AI model via the communication interface;
receive, from the generative AI model, a plurality of warning text candidates;
perform a verification process on the warning text candidates based on predetermined safety criteria and expression rules to determine a warning message;
generate notification data including the warning message and additional information indicating at least a type of the natural disaster, the danger level, a target region, and a recommended action; and
transmit the notification data to a plurality of information processing terminals via the communication interface to cause each information processing terminal to present the warning message by at least one of screen display and audio output.

19. The system according to claim 18, wherein the circuitry is further configured to:
acquire, from each information processing terminal, information concerning an emotional state of a user estimated on a basis of at least one of voice information, image information, and operation information obtained at the information processing terminal, and
select, in accordance with the emotional state of the user, a template from among a plurality of templates corresponding to different emotional states, and generate the prompt sentence by embedding condition information into placeholders of the selected template.

20. A method performed by circuitry via a communication interface coupled to a packet-switched network, the method comprising:
acquiring meteorological information as weather information from at least one external source via the communication interface;
acquiring sensor data from at least one sensor;
analyzing the weather information and the sensor data to generate an analysis result;
predicting an occurrence of a natural disaster based on the analysis result;
generating an alert relating to the predicted natural disaster; and
notifying the alert to related organizations and residents via the communication interface.
